(19) United States
(12) Patent Application Publication
(10) Pub. No.: US 2016/0219578 A1
(43) Pub. Date: Jul. 28, 2016

(54) COOPERATIVE MULTI-ANTENNA TRANSMITTING AND RECEIVING METHOD AND APPARATUS FOR MOBILE COMMUNICATION SYSTEM, AND METHOD FOR CONFIGURING CLUSTER FOR THE SAME

(71) Applicant: ELECTRONICS AND TELECOMMUNICATIONS RESEARCH INSTITUTE, Daejeon (KR)

(72) Inventors: Kwang Jae LIM, Daejeon (KR); Seokki KIM, Daejeon (KR); Anseok LEE, Daejeon (KR); Eunkyung KIM, Daejeon (KR); Seung-Kwon BAEK, Daejeon (KR)

(73) Assignee: ELECTRONICS AND TELECOMMUNICATIONS RESEARCH INSTITUTE, Daejeon (KR)

(21) Appl. No.: 15/009,326

(22) Filed: Jan. 28, 2016

(30) Foreign Application Priority Data
Jan. 28, 2015 (KR) 10-2015-0013806
Jan. 28, 2015 (KR) 10-2015-0013807
Jan. 28, 2015 (KR) 10-2015-0013808

(51) Int. Cl. H04W 72/04; H04B 7/04

(52) U.S. Cl. CPC H04W 72/0413; H04B 7/0413; H04W 72/0446; H04W 72/042

(57) ABSTRACT

A target terminal in a mobile communication system transmits a first uplink cooperative MIMO signal in a first uplink subframe to a cooperating device selected from among a plurality of repeaters for relaying signals and a plurality of terminals except a target terminal for cooperative MIMO transmission and reception, and transmits a second uplink cooperative MIMO signal directly in a second uplink subframe to a base station. The cooperating device amplifies the first uplink cooperative MIMO signal and transmits an amplified first uplink cooperative MIMO signal in the second uplink subframe to the a base station.

### CROSS-REFERENCE TO RELATED APPLICATION

This application claims priority to and the benefit of Korean Patent Application Nos. 10-2015-0013808, 10-2015-0013806, and 10-2015-0013807 filed in the Korean Intellectual Property Office on Jan. 28, 2015, Jan. 28, 2015, and Jan. 28, 2015, the entire contents of which are incorporated herein by reference.

### BACKGROUND OF THE INVENTION

(a) Field of the Invention

The present invention relates to a cooperative multi-antenna transmitting and receiving method and apparatus for a mobile communication system, and method for configuring cluster for the same, and more particularly, to an uplink and downlink cooperative multi-antenna transmitting and receiving method using a terminal or a repeater.

(b) Description of the Related Art

MIMO (Multiple-Input Multiple-Output) is a technique using multiple antennas in downlink and uplink between a base station and a terminal. MIMO has brought improvements in transmission capacity and signal quality for uplink and downlink transmissions by spatial multiplexing and spatial diversity. The performance improvement offered by MIMO is limited by a number of base station antennas, a number of terminal antennas, a distance between antennas, and channel correlation characteristics. Compared to the base station, the number of antennas that the terminal can have and the distance between antennas at the terminal are further limited because of physical size limitations.

For example, if the base station is equipped with eight antennas and the terminal has two antennas, the maximum number of spatially multiplexed data streams that can be sent in downlink is two. Accordingly, MIMO performance is limited by the number of terminal antennas and the distance between antennas at the terminal. Cooperative communication is required to improve a user terminal's transmission/receiving capacity and signal quality, and most of the mobile communication systems so far have been dealing with inter-base station cooperation (in the case of LTE, CoMP, dual connectivity, etc.).

However, inter-base station cooperation cannot overcome the aforementioned limitations on user terminals, and there is a need for inter-terminal cooperative communication by which a large number of geographically widely dispersed terminals cooperate with each other.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a cooperative multi-antenna transmitting and receiving method and apparatus for a mobile communication system, and method for configuring cluster for the same which offer higher spatial multiplexing capability and greater spatial diversity than the number of terminal antennas normally allows, with the cooperation of other terminals or repeaters.

According to an exemplary embodiment of the present invention, a cooperating cluster configuring method for a cooperative MIMO (Multiple-Input Multiple-Output) transmission and reception in a base station of a mobile communication system is provided. The method comprises selecting a plurality of candidate cooperating devices to cooperate for the cooperative MIMO transmission and reception from among a plurality of repeaters for relaying signals and a plurality of terminals except a target terminal for cooperative MIMO transmission and reception, selecting at least one cooperating device from among the plurality of candidate cooperating devices based on signal quality information measured between the plurality of candidate cooperating devices and the target terminal, generating a cooperating cluster including the at least one cooperating device, and transmitting configuration information of the cooperating cluster to the target terminal.

The selecting at least one cooperating device may comprise selecting a candidate cooperating device having a signal quality value higher than a threshold voltage as the cooperating device, based on a plurality of first signal quality values measured, by the target terminal, from discovery ranging signals sent from the plurality of candidate cooperating devices, respectively.

The selecting at least one cooperating device may further comprise calculating transmission timing offset values of the discovery ranging signals sent from the plurality of candidate cooperating devices, respectively, and transmitting the transmission timing offset values to the plurality of candidate cooperating devices, respectively.

The selecting at least one cooperating device may comprise selecting a candidate cooperating device having a signal quality value higher than a threshold voltage as the cooperating device, based on a plurality of signal quality values measured, by the plurality of candidate cooperating devices, respectively, from a discovery ranging signal sent from the target terminal.

The selecting at least one cooperating device may further comprise calculating a transmission timing offset value of the discovery ranging signal sent from the target terminal, and transmitting the transmission timing offset value to the target terminal.

According to another exemplary embodiment of the present invention, a cooperative multi-antenna receiving method for a target terminal in a mobile communication system is provided. The method comprises receiving a downlink cooperative MIMO signal directly through a downlink subframe from a base station, receiving an amplified downlink cooperative MIMO signal transmitted through an uplink subframe, from a cooperating device selected from among a plurality of repeaters for relaying signals and a plurality of terminals except a target terminal for cooperative MIMO transmission and reception, wherein the downlink cooperative MIMO signal is received and amplified by the cooperating device, and combining the downlink cooperative MIMO signal directly received from the base station and the amplified downlink cooperative MIMO signal received from the cooperating device and demodulating data.

The receiving an amplified downlink cooperative MIMO signal transmitted through an uplink subframe may comprise receiving a reception timing offset value calculated based on a propagation delay between the cooperating devices and the target terminal from the base station, and receiving the amplified downlink cooperative MIMO signal at the reception timing adjusted by applying the reception timing offset value to the start time of the uplink subframe.

According to yet another exemplary embodiment of the present invention, a cooperative multi-antenna transmitting method for a target terminal in a mobile communication system is provided. The method comprises transmitting a first uplink cooperative MIMO signal in a first uplink subframe to a cooperating device selected from among a plurality of repeaters for relaying signals and a plurality of terminals except a target terminal for cooperative MIMO transmission and reception, and transmitting a second uplink cooperative MIMO signal directly in a second uplink subframe to a base station, wherein the first uplink cooperative MIMO signal is amplified by the cooperating device and an amplified first uplink cooperative MIMO signal is transmitted in the second uplink subframe, by the cooperating device, to the a base station.

The transmitting a first uplink cooperative MIMO signal may comprise receiving a transmission timing offset value calculated based on a propagation delay between the cooperating devices and the target terminal from the base station, and transmitting the first uplink cooperative MIMO signal to the cooperating device at a transmission timing adjusted by applying the transmission timing offset value to the start time of the first uplink subframe.

The first uplink cooperative MIMO signal may be received at a reception timing adjusted by applying a reception timing offset value to the start time of a third uplink subframe by the cooperating device, and the reception timing offset value may be calculated based on a propagation delay between the cooperating devices and the target terminal by the base station.

According to yet another exemplary embodiment of the present invention, a cooperative multi-antenna transmitting method for a cooperating device in a mobile communication system is provided. The method comprises receiving a downlink cooperative MIMO signal in a downlink subframe from a base station, amplifying the downlink cooperative MIMO signal, and transmitting an amplified downlink cooperative MIMO signal in an uplink subframe to a target terminal.

The transmitting the amplified downlink cooperative MIMO signal may comprise receiving a transmission timing offset value calculated based on a propagation delay between the cooperating device and the target terminal from the base station, and transmitting the amplified downlink cooperative MIMO signal to the target terminal at a transmission timing adjusted by applying the transmission timing offset value to the start time of the uplink subframe.

According to yet another exemplary embodiment of the present invention, a cooperative multi-antenna transmitting method for a base station in a mobile communication system is provided. The method comprises transmitting a downlink cooperative MIMO signal directly through a downlink subframe to a target terminal, and transmitting the downlink cooperative MIMO signal in the downlink subframe, through a cooperating device selected from among a plurality of repeaters for relaying signals and a plurality of terminals except a target terminal for cooperative MIMO transmission and reception, to the target terminal, wherein the downlink cooperative MIMO signal is transmitted in an uplink subframe, by the cooperating device, to the target terminal.

The method may further comprise calculating a reception timing offset value of the target terminal and a transmission timing offset value of the cooperating device, based on a propagation delay between the cooperating device and the target terminal from the base station, wherein a reception timing of the downlink cooperative MIMO signal by the target terminal using the reception timing offset value of the target terminal, or a transmission timing of the downlink cooperative MIMO signal by the cooperating device using the transmission timing offset value of the cooperating device.

The method may further comprise allocating the uplink subframe to the cooperating device, measuring the received power of the downlink cooperative MIMO signal sent from the cooperating device to the target terminal, and determining a reuse of the uplink subframe based on the received power.

The method may further comprise allocating the uplink subframe to the cooperating device, calculating the received interference power received by the target terminal from an uplink signal send from other user terminal, and reusing the uplink subframe for the other user terminal based on the received interference power.

According to yet another exemplary embodiment of the present invention, a cooperative multi-antenna receiving method for a base station in a mobile communication system is provided. The method comprises receiving a first uplink cooperative MIMO signal in a first uplink subframe, through a cooperating device selected from among a plurality of repeaters for relaying signals and a plurality of terminals except a target terminal for cooperative MIMO transmission and reception, from a target terminal, receiving a second uplink cooperative MIMO signal directly in a second uplink subframe from the target terminal, and combining the first uplink cooperative MIMO signal and the second uplink cooperative MIMO signal and demodulating data.

The method may further comprise calculating a transmission timing offset value of the target terminal and a reception timing offset value of the cooperating device, based on a propagation delay between the cooperating device and the target terminal from the base station, wherein a transmission timing of the first uplink cooperative MIMO signal by the target terminal using the transmission timing offset value of the target terminal, or a reception timing of the first uplink cooperative MIMO signal by the cooperating device using the reception timing offset value of the cooperating device.

The method may further comprise allocating a third uplink subframe for transmitting of the first uplink cooperative MIMO signal to the target terminal cooperating device, calculating the received power of the first uplink cooperative MIMO signal send from the target terminal to the cooperating device in the third uplink subframe, and reusing the third uplink subframe for uplink transmission of other user terminal based on the received power.

The method may further comprise allocating a third uplink subframe for transmitting of the first uplink cooperative MIMO signal to the target terminal cooperating device, calculating the received power of the first uplink cooperative MIMO signal received by a cooperating device of other cooperating cluster, wherein the first uplink cooperative MIMO signal is transmitted in the third uplink subframe from the target terminal to the cooperating device, and reusing the third uplink subframe for an uplink cooperative MIMO transmission of the other cooperating cluster based on the received power.

### BRIEF DESCRIPTION OF THE DRAWINGS

FIG. 1 is a view showing an example of a mobile communication system according to an exemplary embodiment of the present invention.

FIG. 2 is a view showing an example of a procedure for a base station to form a cooperating cluster according to an exemplary embodiment of the present invention.

FIG. 3 is a view showing another example of a procedure for a base station to form a cooperating cluster according to an exemplary embodiment of the present invention.

FIG. 4 is a view showing an example of uplink and downlink timings of cooperative MIMO transmission and reception according to an exemplary embodiment of the present invention.

FIG. 5 is a view showing an example of transmission and reception of a discovery ranging signal at a cooperating device and a target terminal according to an exemplary embodiment of the present invention.

FIG. 6 is a view showing an example of radio resources used for uplink cooperative MIMO according to an exemplary embodiment of the present invention.

FIG. 7 is a view showing an example of an uplink signal transmission method for uplink cooperative MIMO according to an exemplary embodiment of the present invention.

FIG. 8 is a view showing another example of an uplink signal transmission method for uplink cooperative MIMO according to an exemplary embodiment of the present invention.

FIG. 9 is a view showing an example where a base station reuses radio resources allocated for uplink cooperative MIMO on the basis of interference.

FIG. 10 is a view showing an example of downlink and uplink timings of transmission and reception at a base station, a cooperating device, and a target terminal according to an exemplary embodiment of the present invention.

FIG. 11 is a view showing a method for adjusting the reception timing of a target terminal's uplink cooperative MIMO signal in a cooperating device according to an exemplary embodiment of the present invention.

FIG. 12 is a view for explaining a method for adjusting the transmission timing of an uplink cooperative MIMO signal in a target terminal according to an exemplary embodiment of the present invention.

FIG. 13 is a view showing an example of radio resources used for downlink cooperative MIMO according to an exemplary embodiment of the present invention.

FIG. 14 is a view showing an example of a downlink signal transmission method for downlink cooperative MIMO according to an exemplary embodiment of the present invention.

FIG. 15 is a view showing another example of a downlink signal transmission method for downlink cooperative MIMO according to an exemplary embodiment of the present invention.

FIG. 16 is a view showing an example where a base station reuses radio resources allocated for downlink cooperative MIMO on the basis of interference.

FIG. 17 is a view showing an example of downlink and uplink timings of transmission and reception at a base station, a cooperating device, and a target terminal according to an exemplary embodiment of the present invention.

FIG. 18 is a view showing a method for adjusting the reception timing of a cooperating device's relay signal in a target terminal according to an exemplary embodiment of the present invention.

FIG. 19 is a view for explaining a method for adjusting the transmission timing of a relay signal in a cooperating device according to an exemplary embodiment of the present invention.

FIG. 20 is a view schematically showing a cooperative multi-antenna transmitting and receiving apparatus of a target terminal according to an exemplary embodiment of the present invention.

FIG. 21 is a view schematically showing a cooperative multi-antenna transmitting and receiving apparatus of a cooperating device according to an exemplary embodiment of the present invention.

FIG. 22 is a view schematically showing a cooperative multi-antenna transmitting and receiving apparatus of a base station according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

In the specification, a terminal may indicate user equipment UE, a mobile terminal (MT), a mobile station (MS), an advanced mobile station (AMS), a high reliability mobile station (HR-MS), a subscriber station (SS), a portable subscriber station (PSS), an access terminal (AT), etc., and may include all or some of the functions of the UE, MT, MS, AMS, HR-MS, SS, PSS, AT, etc.

Also, a base station (BS) may indicate a node B (NodeB), an evolved node B (eNB), an advanced base station (ABS), a high reliability base station (HR-BS), an access point (AP), a radio access station (RAS), a base transceiver station (BTS), etc., and may include all or some of the functions of the nodeB, eNB, BS, ABS, HR-BS, AP, RAS, BTS, etc.

Now, a cooperative multi-antenna transmitting and receiving method and device for a mobile communication system, and method for configuring cluster for the same according to an exemplary embodiment of the present invention will be described in detail with reference to the drawings.

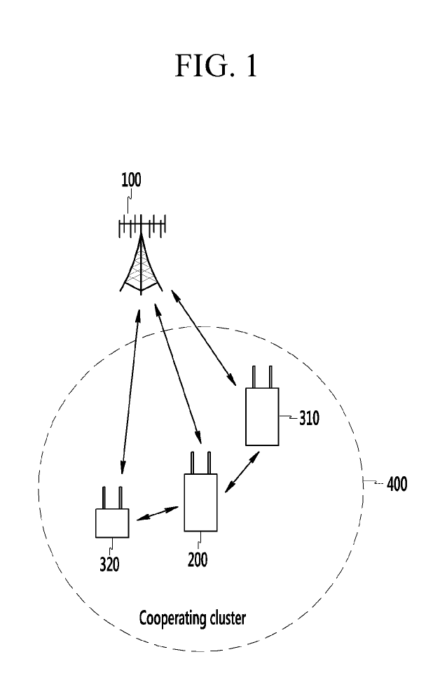

FIG. 1 is a view showing an example of a mobile communication system according to an exemplary embodiment of the present invention.

Referring to FIG. 1, a mobile communication system may include a base station 100, at least one terminal 200 and 310, and at least one repeater 320.

One of the at least one terminal 200 and 310 to serve as a target for cooperative MIMO transmission and reception is referred to as a target terminal 200. A terminal 310, apart from the target terminal 200, to cooperate with the target terminal 200 for cooperative MIMO transmission and reception, is referred to as a cooperating terminal 310, and one of the at least one repeater 320 to cooperate with the target terminal 200 for cooperative MIMO transmission and reception is referred to as a cooperating repeater 320. The cooperating terminal 310 and the cooperating repeater 320 may be collectively referred to as a cooperating device. That is, as the cooperating terminal 310 and the cooperating repeater 320 perform the same function for cooperative MIMO transmission and reception with the target terminal 200, the term “cooperating device” will be used for ease of description when there is no need to distinguish between the cooperating terminal 310 and the cooperating repeater 320. In other words, the cooperating device may refer to either the cooperating terminal 310 or the cooperating repeater 320.

The base station 100 constitutes a cooperating cluster 400 for cooperative MIMO transmission and reception. The cooperating cluster refers to a logical group consisting of one or more cooperating terminals 310 or cooperating repeaters 320 around the target terminal 200, including the target terminal 200.

The cooperating terminal 310 serves to wireless relay a downlink cooperative MIMO signal from the base station 100 to the target terminal 200 in downlink cooperating MIMO transmission, and serves to wireless relay an uplink cooperative MIMO signal from the target terminal 200 to the base station 100 in uplink cooperative MIMO transmission. The cooperating terminal 310 may become a target terminal and have cooperation from other cooperating devices.

The cooperating repeater 320 is a kind of relay that functions to wirelessly relay a cooperative MIMO signal to the terminals 200 and 310 or the base station 100, and may be installed by the mobile communication system's administrator or a user. The cooperating repeater 320 may perform the same function as the cooperating terminal 310.

The cooperating cluster 400 is generated around the target terminal 200 by the base station 100. The base station 100 may generate cooperating clusters respectively for uplink and downlink around one target terminal 400 or one cluster for both uplink and downlink around one target terminal 400.

A signal relayed by the cooperating terminal 310 or the cooperating repeater 320 is transmitted in uplink. For example, the cooperating terminal 310 or the cooperating repeater 320 has the function of receiving and amplifying a downlink cooperative MIMO signal and forwarding the amplified signal in uplink.

Also, the target terminal 200 and the cooperating terminal 310 has the function of receiving a cooperative MIMO signal in uplink, in addition to the primary function of uplink transmission, to achieve cooperative MIMO transmission and reception functions.

The target terminal 200 with the cooperative MIMO transmission and reception function has the function of switching between transmission and reception in uplink, in order to transmit an uplink signal to the base station 100 and receive a cooperative MIMO signal relayed in uplink, or in order to receive a cooperative MIMO signal relayed in uplink and transmit an uplink signal to the base station 100.

For downlink cooperative MIMO transmission and reception, the cooperating terminal 310 or cooperating repeater 320 belonging to the cooperating cluster 400 relays a downlink cooperative MIMO signal from the base station 100 to the target terminal 200 in uplink, and the target terminal 200 receives a downlink MIMO signal received directly from the base station 100 and a downlink MIMO signal relayed in uplink by the cooperating terminal 310 or the cooperating repeater 320, and combines these signals.

For uplink cooperative MIMO transmission and reception, the cooperating terminal 310 or cooperating repeater 320 belonging to the cooperating cluster 400 relays an uplink cooperative MIMO signal from the target terminal 200 to the base station 100 in uplink.

The base station 100 receives an uplink MIMO signal received directly from the target terminal 200 and an uplink MIMO signal relayed in uplink by the cooperating terminal 310 or the cooperating repeater 320, and combines these signals.

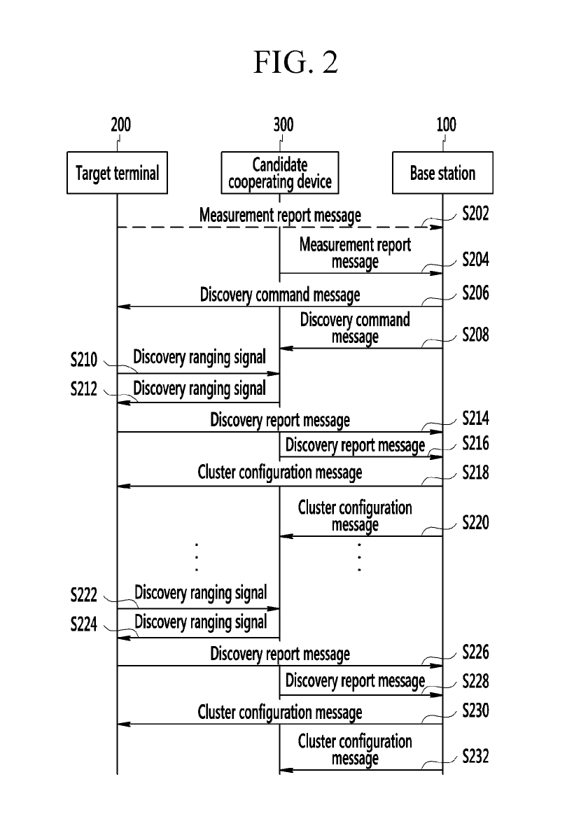

FIG. 2 is a view showing an example of a procedure for a base station to form a cooperating cluster according to an exemplary embodiment of the present invention.

Referring to FIG. 2, the base station 100 selects a candidate cooperating device 300 for the target terminal 200. Generally, terminals in a mobile communication system measure the received signal quality at surrounding base stations, including a serving base station, and report measurement data to the serving base station through a measurement report message. The received signal quality may include signal-to-interference plus noise ratio (SINR), reference signal received power (RSRP), etc.

The base station 100 may instruct terminals and/or repeaters with the cooperative MIMO transmission and reception function to detect, through a measurement configuration message, a random access channel (in the case of LTE, PRACH) signal sent from terminals, and to report the reception quality of the detected random access channel signal to the base station 100 through a measurement report message.

The base station 100 receives a measurement report message from terminals and repeaters (S202 and S204). The base station 100 selects a candidate cooperating device 300 based on the measurement data in the measurement report message.

The base station 100 may compare measurements of the received signal quality at several base stations, reported by the terminals and repeaters, and determine whether the terminals and repeaters are adjacent to one another. For example, whether terminal i and terminal j are adjacent to each other or not may be determined based upon Equation 1. For example, when Equation 1 is satisfied, they are assumed to be adjacent to each other.

(Pi,a−Pj,a)≦T1,a ε A (Equation 1)

Here, Pi,a and Pj,a represent the received signal quality at base station a, measured and reported by terminal i and terminal j, respectively, and T1 represents a threshold value for determining candidates. A represents a group of base stations for which measurements are made and reported.

That is, if the difference between the measurements of the received signal strength at each surrounding base station, made by terminal i and terminal j, is less than a threshold value, the two terminals are assumed to be adjacent to each other and become candidate devices that cooperate with each other.

If the mobile communication system or the terminals or repeaters use a particular positioning mechanism, the base station 100 may determine whether the terminals or repeaters are adjacent to one another or not, based on positioning data of the terminals or repeaters obtained through the mechanism.

The base station 100 may select terminals and/or repeaters located adjacent to the target terminal 200 as candidate cooperating devices 300.

Alternatively, the base station 100 may select a candidate cooperating device 300 without considering whether it is adjacent to the target terminal 200. In this case, a candidate cooperating device 300 may be selected from among all terminals and repeaters with an intra-cell cooperative MIMO transmission and reception function through a particular incentive mechanism. A description of the selection of a candidate cooperating device 300 through an incentive mechanism will be omitted since it will obscure the gist of the invention.

The base station 100 transmits a discovery command message to a target terminal 200 or/and a candidate cooperating device 300 to instruct them to transmit a discovery ranging signal (S206 and S208). The discovery command message may contain the identifier of a target that transmits a discovery ranging signal and the radio resource, transmission sequence, transmission power, and transmission timing offset for the discovery ranging signal.

Upon receiving the discovery command message, the target terminal 200 or/and the candidate cooperating device 300 transmit a discovery ranging signal (S210 and S212). The discovery ranging signal may be configured the same way as a random access signal used for an uplink random access channel in the mobile communication system. The base station 100 uses some or all of the radio resources used as the random access channel for the transmission of a discovery ranging signal. Also, the base station 100 may use some or all of the random access signal or sequence for the discovery ranging signal.

The base station 100 may use the discovery command message to specify the position of a radio resource for the random access channel and a random access channel signal, which are used for the target terminal 200 or/and the candidate cooperating device 300 to transmit a discovery ranging signal.

Upon receiving the discovery ranging signal, the target terminal 200 or/and the candidate cooperating device 300 measure the reception quality and reception timing offset of the discovery ranging signal, and report measurement data to the base station 100 through a discovery report message (S214 and S216).

The base station 100 selects one or more cooperating devices constituting a cooperating cluster for the target terminal 200 based on the measurement data in the discovery report message, and informs the target terminal 200 and/or the cooperating device 300 of the cluster configuration through a cluster configuration message (S218 and S220). FIG. 2 shows an example of selection of a candidate cooperating device 300 as the cooperating device 300. The cluster configuration message may contain one or more of the identifiers of the target terminal 200 and cooperating device 300 constituting a cluster, an uplink or downlink radio resource (e.g., subframe) used for relaying, an uplink radio resource used for the transmission of a relay signal, and the transmission/reception timing offset for the relay signal.

The base station 100 may select a cooperating device 300 for the target terminal 200 based on the measurement data in the discovery report message reported from the target terminal 200 or the candidate cooperating device 300. For example, if the received signal quality Di,j of a discovery ranging signal from a candidate cooperating terminal j, measured and reported by a target terminal i, is higher than or equal to a specific threshold value T2, the base station 100 may select the candidate cooperating terminal j as a cooperating device 300 for the target terminal i. If the received signal quality Dj,i of a discovery ranging signal from the target terminal i, measured and reported by the candidate cooperating terminal j, is greater than or equal to the specific threshold value T2, the base station 100 may select the candidate cooperating terminal j as a cooperating device 300 for the target terminal i.

The base station 100 may properly change and remove the cooperating cluster for the target terminal 200 as the wireless channel changes with time and the terminal moves.

The base station 100 periodically or non-periodically transmits a discovery command message to the target terminal 200 or the candidate cooperating device 300 including a cooperating device 300 belonging to the current cluster so that the target terminal 200 and/or the candidate cooperating device 300 transmit a discovery ranging signal.

Upon receiving the discovery command message, the target terminal 200 or/and the candidate cooperating device 300 transmit a discovery ranging signal (S222 and S224).

As in the cluster generation process, upon receiving the discovery ranging signal, the target terminal 200 or/and the candidate cooperating device 300 measures the received signal quality of and reception timing offset for the discovery ranging signal and reports measurement data to the base station 100 through a discovery report message (S226 and S228).

The base station 100 changes the cooperating devices constituting the cluster for the target terminal 200 based on the measurement data in the discovery report message, and informs the target terminal or the cooperating device(s) to be removed or added about the cluster change through a cluster configuration message (S230 and S232).

Even if the cooperating device(s) belonging to the cluster is not changed, the base station 100 may inform the target terminal 200 or the cooperating device 300 about a change in the transmission/reception timing offset for a relay signal, through a cluster configuration message, to control the relay signal transmission and reception timings.

In the cluster generation process, the base station 100 may make the target terming 200 or the cooperating device 300 to periodically transmit a discovery report message including the measurement results on a discovery ranging signal, without sending a discovery command message.

If there is no cooperating device at all that belongs to the cluster for the target terminal 200, the base station 100 informs the target terminal 200 and the cooperating device 300 about the removal of the cluster through a cluster configuration message.

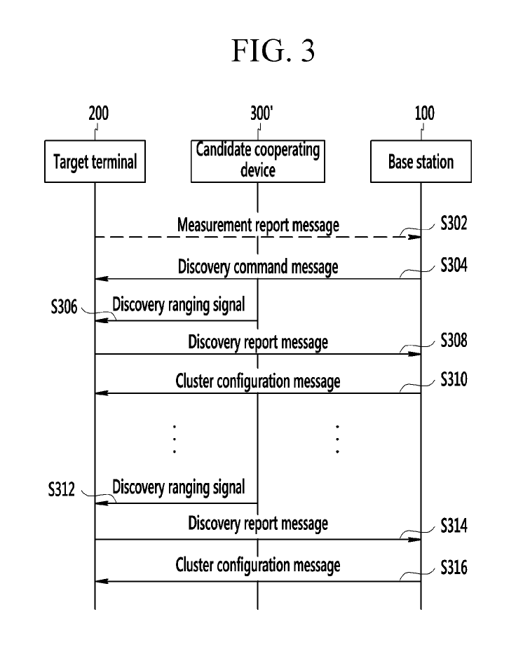

FIG. 3 is a view showing another example of a procedure for a base station to form a cooperating cluster according to an exemplary embodiment of the present invention.

Referring to FIG. 3, a simple cooperating device is a cooperating device pre-installed by the administrator or the user, and is configured to periodically transmit a predetermined discovery ranging signal in a predetermined uplink radio resource.

The base station 100 receives measurement report messages from multiple terminals including the target terminal 200 (S302). The base station 100 selects a candidate simple cooperating device 300′ from among simple cooperating devices, based on measurement data in the measurement report message.

The base station 100 may compare measurements of the received signal quality at several base stations reported by the target terminal 200 with the measurements thereof made by the simple cooperating devices, and determine whether the target terminal 200 and the simple cooperating devices are adjacent to one another.

That is, in Equation 1, i represents the target terminal 200 and j represents a simple cooperating device. As the simple cooperating device is pre-installed, it may be configured to measure the received signal quality at several base stations at the time of initial installation.

Moreover, if the mobile communication system or the target terminal 200 uses a particular positioning mechanism, the base station 100 may determine whether the target terminal 200 and the simple cooperating devices are adjacent to one another or not, based on positioning data of the target terminal 200 obtained through the mechanism or positioning data of the pre-installed simple cooperating devices.

The base station 100 may select a candidate simple cooperating device 300′ depending on whether the target terminal 200 and the simple cooperating devices are adjacent to one another.

The base station 100 may transmit a discovery command message to the target terminal 200 to configure a cooperating cluster for the target terminal 200 (S304). The discovery command message may contain the radio resource in which the candidate simple cooperating device 300′ transmits a discovery ranging signal, and the transmission sequence, transmission power, and transmission timing offset for the discovery ranging signal.

The candidate simple cooperating device 300′ periodically transmits a predetermined discovery ranging signal in a predetermined uplink radio resource (S306).

Upon receiving the discovery command signal, the target terminal 200 receives a discovery ranging signal from the candidate simple cooperating device 300′ and measures the received signal quality of and reception timing offset for the discovery ranging signal, and reports measurement data to the base station 100 through a discovery report message (S308).

The base station 100 selects one or more simple cooperating devices constituting a cooperating cluster for the target terminal 200 based on the measurement data in the discovery report message, and informs the target terminal 200 of the cluster configuration through a cluster configuration message (S310). The cluster configuration message may contain one or more of the identifiers of cooperating devices constituting a cluster, an uplink or downlink subframe used for relaying by the cooperating devices, an uplink subframe used for the transmission of a relay signal, and the transmission/reception timing offset for the relay signal. Information about the discovery ranging signal for the identification of the cooperating devices may be used as the identifiers of the cooperating devices.

For example, if the received signal quality Di,j of a discovery ranging signal from a candidate simple cooperating device j, measured and reported by a target terminal i, is greater than or equal to a specific threshold value T2, the base station 100 may select the candidate simple cooperating device j as a cooperating device for the target terminal i.

As explained with reference to FIG. 2, the base station 100 may need to properly change and remove the cooperating cluster for the target terminal 200 as the wireless channel changes with time and the terminal moves.

The candidate simple cooperating device 300′ periodically transmits a predetermined discovery ranging signal in a predetermined uplink radio resource (S312).

The base station 100 periodically or non-periodically transmits a discovery command message to the target terminal 200 to instruct the target terminal 200 to receive a discovery ranging signal sent from the candidate simple cooperating device 300′ including the simple cooperating device(s) belonging to the current cooperating cluster.

The target terminal 200 receives the discovery ranging signal sent from the candidate simple cooperating device 300′, and as in the cluster generation process, measures the reception quality of and reception timing offset for the discovery ranging signal and reports measurement data to the base station 100 through a discovery report message (S314).

The base station 100 replaces the simple cooperating device(s) constituting the cooperating cluster for the target terminal 200 based on the measurement data in the discovery report message, and informs the target terminal 200 about the cooperating cluster change through a cluster configuration message (S316).

Even if the cooperating device(s) 300′ belonging to the cooperating cluster are not replaced, the base station 100 may inform the target terminal 200 about a change in the reception timing offset for a relay signal, through a cluster configuration message, to control the relay signal reception timing.

In the cluster generation process, the base station 100 may make the target terming 200 to periodically transmit a discovery report message including the measurement results on a discovery ranging signal periodically transmitted by simple cooperating devices, without sending any discovery command message.

If there is no cooperating device at all that belongs to the cooperating cluster for the target terminal 200, the base station 100 informs the target terminal 200 about the removal of the cluster through a cluster configuration message.

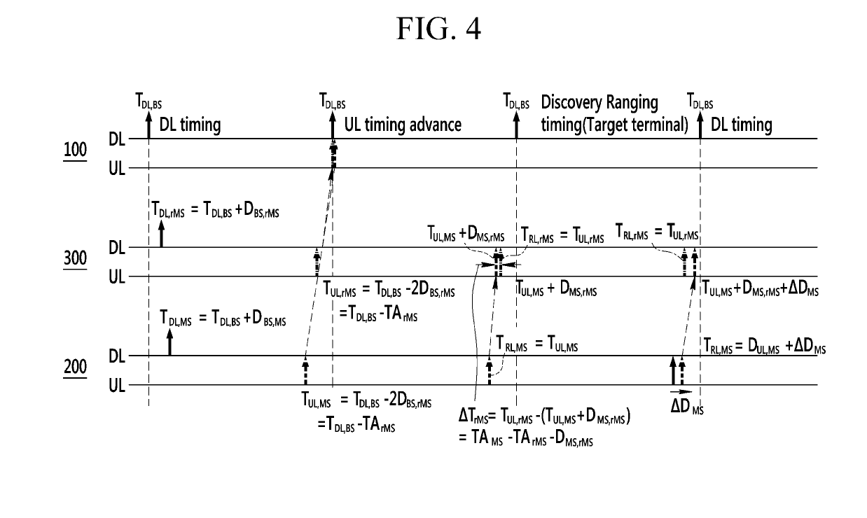

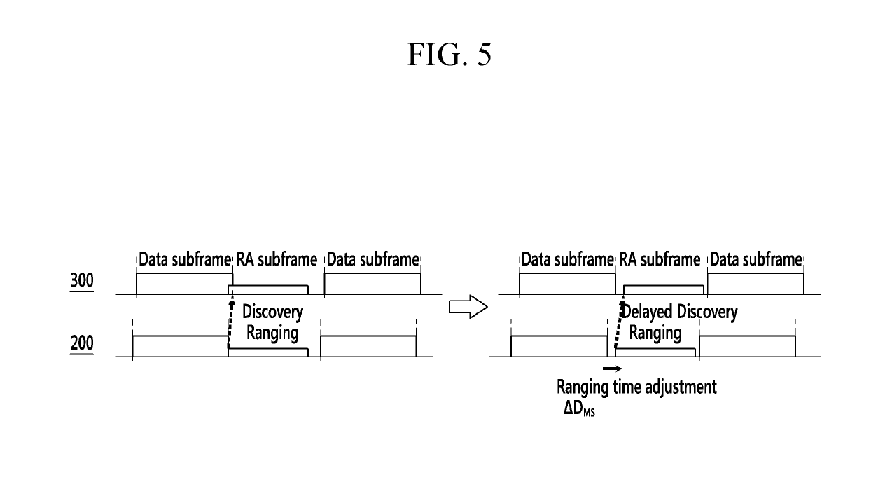

FIG. 4 is a view showing an example of uplink and downlink timings of cooperative MIMO transmission and reception according to an exemplary embodiment of the present invention. FIG. 5 is a view showing an example of transmission and reception of a discovery ranging signal at a cooperating device and a target terminal according to an exemplary embodiment of the present invention.

As in a general mobile communication system, a target terminal 200 and a cooperating device 300 including a candidate cooperating device set the timings of downlink reception and uplink transmission from and to a base station 100.

For synchronized uplink reception at the base station 100, the base station 100 instructs all terminals including cooperating devices 300 to adjust the transmission timing in a random access procedure.

Referring to FIG. 4, a downlink signal sent from the base station 100 at T_{DL,BS} (DL timing) as the frame starting point reaches the cooperating device 300 at T_{DL,rMS}(T_{=DL,BS}+D_{BS,rMS}), and reaches the target terminal 200 at T_{DL,MS}(=T_{DL,BS}+D_{BS,MS}). D_{BS,rMS} is the propagation delay between the base station 100 and the cooperating device 300, and D_{BS,MS} is the propagation delay between the base station 100 and the target terminal 200.

The target terminal 200 and the cooperating device 300 transmit uplink random access signals, respectively, at the time of downlink reception, and the base station 100 measures the difference between the reception of the uplink random access signals sent from the target terminal 200 and the cooperating device 300, respectively, and the uplink reference timing for the base station 100. The base station 100 transmits a TA (Timing Advance) value for reception timing adjustment to the target terminal 200 and the cooperating device 300 as a response to the random access.

Generally, the base station 100 may set the TA value (TA_{MS}) for the target terminal 200 to 2D_{BS,MS} and set the TA value (TA_{rMS}) for the cooperating device 300 to 2D_{BS,rMS}.

The target terminal 200 and the cooperating 300 adjust the uplink transmission timing to T_{UL,rMS}(=T_{DL,BS}−TA_{rMS}) and T_{UL,MS}(=T_{DL,BS}−TA_{MS}), respectively, depending on the TA values (TA_{MS} and TA_{rMS}).

This procedure is identical to a procedure for a terminal to adjust the uplink transmission timing for uplink synchronization in a general mobile communication system.

If the target terminal 200 transmits a discovery ranging signal at its uplink transmission timing T_{RL,MS}(=T_{UL,MS}), the discovery ranging signal reaches the cooperating device 300 at T_{UL,MS}+D_{MS,rMS}. D_{MS,rMS} is the propagation delay between the terminal 200 and the cooperating device 300. There is a time difference Δ T_{rMS}[=T_{UL,rMS}−(T_{UL,MS}+D_{MS,rMS})=TA_{MS}−TA_{rMS}−D_{MS,rMS}] between the reception of the discovery ranging signal and the uplink reference timing T_{RL,rMS} for the cooperating device 300. As shown in FIG. 5, the discovery ranging signal received by the cooperating device 300 may partially overlap the previous uplink subframe.

Also, when the cooperating device 300 transmits an uplink signal to the base station 100 in the subframe preceding the subframe (RA subframe) with an uplink random access resource, a transmission/reception switching time is needed for the cooperating device 300's uplink transmission and discovery ranging signal reception. Accordingly, in order for the discovery ranging signal sent from the target terminal 200 to be received within the subframe (RA subframe) of the cooperating device 300, the base station 100 transmits a transmission timing offset Δ D_{MS} of the discovery ranging signal through a cluster configuration message to the target terminal 200, and the target terminal 200 transmits the discovery ranging signal at T_{RL,MS}(=T_{UL,MS}+Δ D_{MS}), which is obtained by applying the transmission timing offset Δ D_{MS}. Δ D_{MS} is a value that is determined by the base station 100, taking into consideration the difference Δ D in propagation delays of the base station 100, the target terminal 200, and the cooperating device 300, and the transmission/reception switching time T_{SW}.

Although FIG. 4 and FIG. 5 illustrate an example of transmission of a discovery ranging signal by the target terminal 200, a candidate cooperating device 300 also transmits a discovery ranging signal at the uplink transmission timing adjusted by a transmission timing offset value contained in a discovery command message.

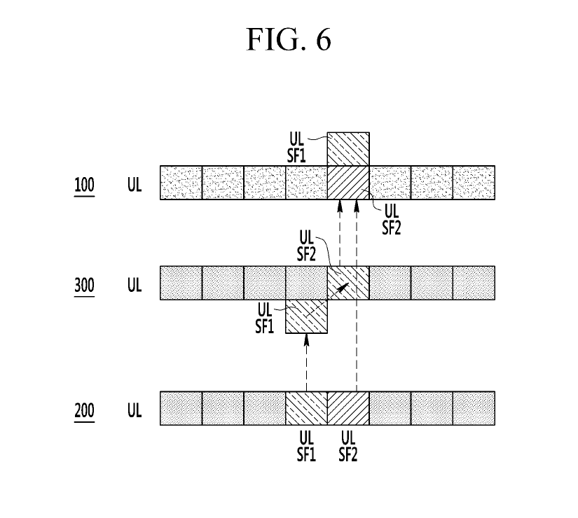

FIG. 6 is a view showing an example of radio resources used for uplink cooperative MIMO according to an exemplary embodiment of the present invention.

Referring to FIG. 6, a target terminal 200 transmits a MIMO signal to a cooperating device 300 on uplink (UL) radio resources in the uplink subframe UL SF1, allocated by a base station 100, and the cooperating device 300 receives the MIMO signal, which is the uplink signal from the target terminal 200, in the uplink subframe UL SF1 allocated by the base station 100.

The target terminal 200 transmits a MIMO signal to the base station 100 on UL radio resources in another uplink subframe UL SF2 allocated by the base station 100. The cooperating device 300 amplifies the uplink signal previously received from the target terminal 200 on radio resources at the uplink subframe UL SF1 and transmits the amplified signal in the uplink subframe UL SF2 allocated by the base station 100. The radio resources in uplink subframe UL SF2 where the target terminal 200 transmits the MIMO signal to the base station 100 are the same as those in the uplink subframe UL SF2 where the cooperating device 300 transmits the amplified MIMO signal to the base station 100.

The base station 100 receives the signal sent from the target terminal 200 and the signal sent from the cooperating device 300 in the uplink subframes UL SF1 and UL SF2, respectively. The target terminal 200 assumes that an uplink signal sent to the cooperating device 300 to be relayed by the cooperating device 300 is transmitted by virtual additional antennas, aside from the antennas originally equipped in the target terminal 200, and generates and transmits a MIMO signal. A signal relayed by the cooperating device 300 and a signal sent directly to the base station 100 are transmitted by the same antenna of the target terminal 200, but these two types of signals are transmitted in different radio resources through different physical paths. Accordingly, the target terminal 200 may transmit a MIMO signal which can be transmitted using a larger number of antennas than the number of transmit antennas at the target terminal 200.

For example, if the target terminal 200 transmits an uplink signal by n transmit antennas and (r−1) cooperating devices 300 relay the uplink signal, it means that the target terminal 200 may transmit a signal using (n×r) transmit antennas. Accordingly, if the base station 100 detects an uplink signal by m receive antennas and m≧n×r, the base station 100 may receive a maximum of (n×r) data streams or layers in uplink from the target terminal 200.

As such, the target terminal 200 is able to transmit an additional signal through the medium of the cooperating devices 300. Hence, the uplink data rate of the target terminal 200 increases linearly in proportion to the number of cooperating devices 300 used for relaying and the amount of radio resources used.

The uplink (UL) radio resources the cooperating devices 300 have used for relaying may be reused for relay transmissions from other cooperating clusters far away from the current cluster, causing less interference, or for uplink transmissions from other terminals.

Accordingly, cooperative MIMO transmission with higher transmission capacity from the target terminal 200 can be achieved without a decrease in cell capacity caused by the use of radio resources for relaying, and the transmission capacity of the cell increases.

FIG. 6 illustrates radio resources on a FDD basis, and the cooperative MIMO transmission method and procedure according to the exemplary embodiment of the present invention are also applicable on a TDD basis.

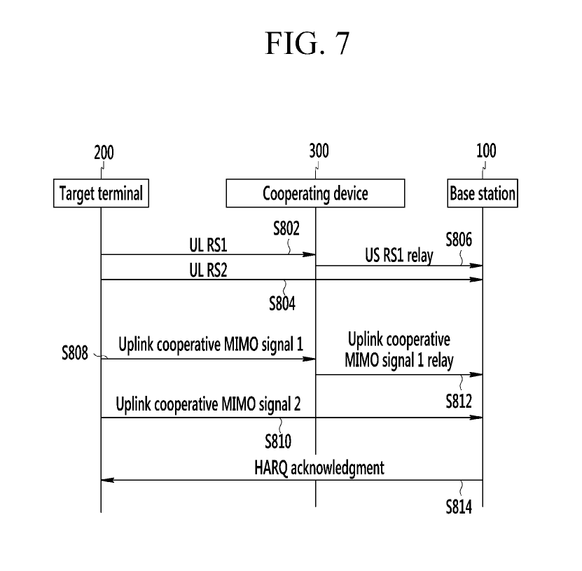

FIG. 7 is a view showing an example of an uplink signal transmission method for uplink cooperative MIMO according to an exemplary embodiment of the present invention.

Referring to FIG. 7, uplink cooperative MIMO transmission refers to MIMO transmission and reception that uses one or more uplink signals relayed by one or more cooperating devices 300, as well as an uplink signal sent directly from a target terminal 200 to a base station 100. In order to select an appropriate MIMO transmission scheme for the target terminal 200, the base station 100 needs to estimate the channel state information (CSI) of a combined channel by using the target terminal 200's reference signal relayed by the cooperating device 300, as well as a reference signal received directly from the target terminal 200.

The target terminal 200 transmits a reference signal group 1 (UL RS1) in uplink as instruction information of a cluster configuration message or instruction information of a downlink control channel from the base station 100 (S802).

The target terminal 200 transmits a reference signal group 2 (UL RS2) directly to the base station 100 as instruction information of a cluster configuration message or instruction information of a downlink control channel from the base station 100 (S804).

The cooperating device 300 receives and amplifies the reference signal group 1 (UL RS1) sent from the target terminal 200 and relays the amplified reference signal group 1 (UL RS1) to the base station 100 in an uplink subframe (S806).

The reference signal group 2 (UL RS2) is signals transmitted from the target terminal 200 by virtual additional transmit antennas, which are different from those of the reference signal group 1 (UL RS1). For example, in the case where (r−1) cooperating devices 300 perform uplink cooperative MIMO transmission in cooperation, the reference signal group 1 (UL RS1) consists of (r−1) different reference signals transmitted in (r−1) different uplink radio resources to (r−1) cooperating devices. Each of the reference signals of the reference signal group 1 (UL RS1) is transmitted using all or some of the transmit antennas at the target terminal 200.

The base station 100 receives the target terminal 200's reference signal group 1 (UL RS1) relayed from the cooperating device 300 and the reference signal group 2 (UL RS2) sent directly from the target terminal 200, and estimates the CSI of a combined channel for the two received signal groups (UL RS1 and UL RS2).

The CSI estimation by the base station 100 is identical to the CSI estimation for general MIMO where, if the target terminal 200 transmits a signal by n transmit antennas and (r−1) cooperating devices 300 relay it, the target terminal 200 uses (n×r) transmit antennas. For example, if the target terminal 200 uses a transmit antenna 1 and a transmit antenna 2 and one cooperating device 300 cooperates with the target terminal 200, reference signals 1 and 2 of the reference signal group 1 are transmitted in an uplink radio resource 1 by the transmit antenna 1 and transmit antenna 2, and reference signals 3 and 4 of the reference signal group 2 are transmitted by the transmit antenna 1 and transmit antenna 2 of the target terminal 200 and also by virtual transmit antennas 3 and 4. The reference signals 3 and 4 are different from those of the reference signal group 1 and transmitted in an uplink radio resource 2. The cooperating device 300 receives and amplifies the reference signal group 1 and forwards it to the base station 100 in uplink radio resource 2. The base station 100 assumes that the reference signal group 1 and reference signal group 2 are reference signals transmitted in the uplink radio resource 2 by the transmission antennas 1 to 4 of the target terminal 200, and estimates CSI.

A signal relayed by the cooperating device 300 may include a reference signal alone or the entire corresponding subframe. As instruction information of a cluster configuration message or instruction information of a downlink control channel from the base station 100, the target terminal 200 may periodically transmit a reference signal, and the cooperating device 300 may periodically relay the target terminal 200's reference signal in uplink.

The uplink subframe used for relaying for CSI estimation may be identical to the uplink subframe used for cooperative MIMO signal transmission in which data of the target terminal 200 is carried.

In the transmission of data to the target terminal 200 after initial reference signal transmission, if an uplink subframe for data transmission to the target terminal 200 contains a reference signal, the process of relaying the target terminal 200's reference signal for CSI estimation may be used only for initial data transmission and is omitted in subsequent data transmissions.

Similarly to general MIMO transmission, the base station 100 schedules an open-loop or closed-loop, spatial multiplexing or spatial diversity MIMO data transmission to the target terminal 200 according to the CSI estimate, and allocates an uplink, spatial multiplexing, or spatial diversity MIMO transmission over a downlink control channel. The difference between cooperative MIMO according to an exemplary embodiment of the present invention and general MIMO is that, by estimation of the CSI of a combined channel, an uplink channel between the target terminal 200 and the base station 100 may be regarded as a channel for achieving spatial multiplexing or spatial diversity with a larger number of antennas than the actual number of transmit antennas at the target terminal 200, and allocated for transmission of signals with high data rates.

The target terminal 200 transmits uplink cooperative MIMO signal 1 in an uplink subframe (UL SF1 of FIG. 6) allocated for transmission to the cooperating device 300 through a cluster configuration message or over a downlink control channel (S808).

Also, the target terminal 200 transmits uplink cooperative MIMO signal 2 in an uplink subframe (UL SF2 of FIG. 6) allocated for direct transmission to the base station 100 through a cluster configuration message or over a downlink control channel (S810). The cooperative MIMO signal 1 and the cooperative MIMO signal 2 are different MIMO signals that are transmitted by different virtual antenna groups.

As mentioned above, in the case where (r−1) cooperating devices perform uplink cooperative MIMO transmission in cooperation, the cooperative MIMO signal 1 consists of (r−1) different reference signals transmitted in (r−1) different uplink radio resources to (r−1) cooperating devices 300. Each uplink cooperative MIMO signal 1 is transmitted using all or some of the transmit antennas at the target terminal 200.

The cooperating device 300 receives and amplifies an uplink cooperative MIMO signal 1 sent from the target terminal 200 in an uplink subframe (UL SF1 of FIG. 6), and relays the amplified uplink cooperative MIMO signal 1 to the base station 100 in an allocated uplink subframe (UL SF2 of FIG. 6) (S812). The base station 100 may provide the cooperating device 300 with the positions of the target terminal 200's uplink subframes (UL SF1 and UL SF2 of FIG. 6) used for relaying, over a downlink control channel. The base station 100 may specify the positions of the uplink subframes (UL SF1 and UL SF2 of FIG. 6) and inform the cooperating device 300 of these positions through a cluster configuration message in a cluster formation procedure.

The uplink subframe (UL SF2 of FIG. 6) where the cooperating device 300 uses to transmit to the base station 100 is identical to the uplink subframe (UL SF2 of FIG. 6) where the target terminal 200 uses to transmit the uplink cooperative MIMO signal 2. An uplink cooperative MIMO signal 1 relayed to the base station 100 by the cooperating device 300 may be transmitted using all radio resources in the uplink subframe, or using part of radio resources allocated for the target terminal 200.

Moreover, the uplink subframe (UL SF2 of FIG. 6) where the cooperating device 300 uses to transmit a cooperative MIMO signal to the base station 100 may be identical to the uplink subframe in which the cooperating device 300 relays the target terminal 200's reference signal 1 (UL RS1) for CSI estimation.

The base station 100 receives the uplink cooperative MIMO signal 2 received directly from the target terminal 200 and the uplink cooperative MIMO signal relayed by the cooperating device 300, and combines the two received signals to demodulate data.

The base station 100 reports the success or failure of the demodulation attempt to the target terminal 200 as a HARQ acknowledgment (S814). If the demodulation attempt is successful, the base station 100 transmits a positive acknowledgment ACK to the target terminal 200, or if the demodulation attempt fails, the base station 100 transmits a negative acknowledgment NACK to the target terminal 200.

If the HARQ acknowledgment is negative NACK, the base station 100 retransmits HARQ.

Depending on the HARQ acknowledgment, the base station 100 may allocate retransmission or a new transmission over a downlink control channel.

The cooperating device 300 receives and amplifies the target terminal 200's signal, and forwards it to the base station 100 as instruction information of a cluster configuration message or a downlink control channel, regardless of whether a HARQ is initially transmitted or re-transmitted.

The base station 100 may allocate the same radio resources used for transmission of MIMO signals from other user terminals or cooperative MIMO signals from other cooperating clusters, in order to transmit the target terminal 200's cooperative MIMO signal by multi-user MIMO. That is, cooperative MIMO signals transmitted for different cooperating clusters may be transmitted in the same radio resources by different precoding strategies. Moreover, MIMO signals sent to other terminals and cooperative MIMO signals transmitted for a cooperating cluster may be transmitted in the same radio resources by different precoding strategies.

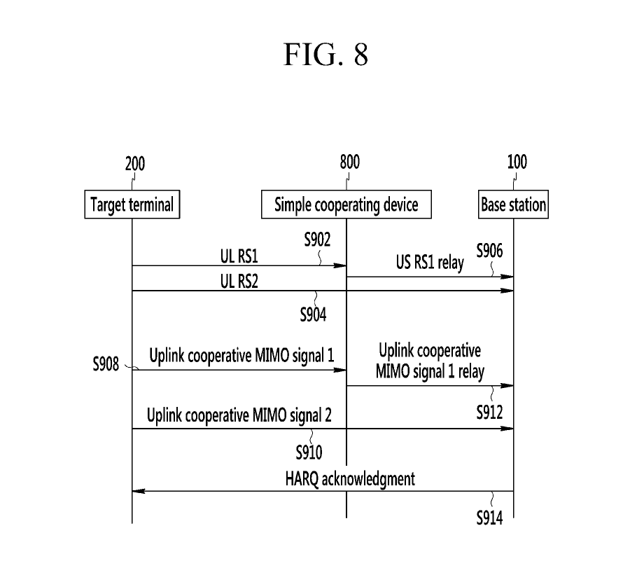

FIG. 8 is a view showing another example of an uplink signal transmission method for uplink cooperative MIMO according to an exemplary embodiment of the present invention.

Referring to FIG. 8, a simple cooperating device 800 is a cooperating device that is pre-installed by the administrator or the user. An uplink subframe to be received by the simple cooperating device 800 and an uplink subframe for relaying may be specified at regular intervals. The simple cooperating device 800 is a cooperating device that is configured to receive a signal in a specified uplink subframe and amplify and forward the received signal in a specified uplink subframe, without having to know which cluster for which target terminal 200 it belongs to, which uplink subframe it receives depending on the target terminal 200, and in which uplink subframe the signal is amplified and forwarded to the target terminal 200. As an uplink subframe to be received by the simple cooperating device 800 and an uplink subframe for relaying are specified, the uplink signal transmission process for uplink cooperative MIMO shown in FIG. 6 may be simplified by using the simple cooperating device 800. The detailed description on uplink signal transmission process S902 to S914 for uplink cooperative MIMO shown in FIG. 8 is omitted since it is identical to the uplink signal transmission process S908 to S814 shown in FIG. 7. The simple cooperating device 800 may be the simple cooperating device 300′ of FIG. 3 or other devices.

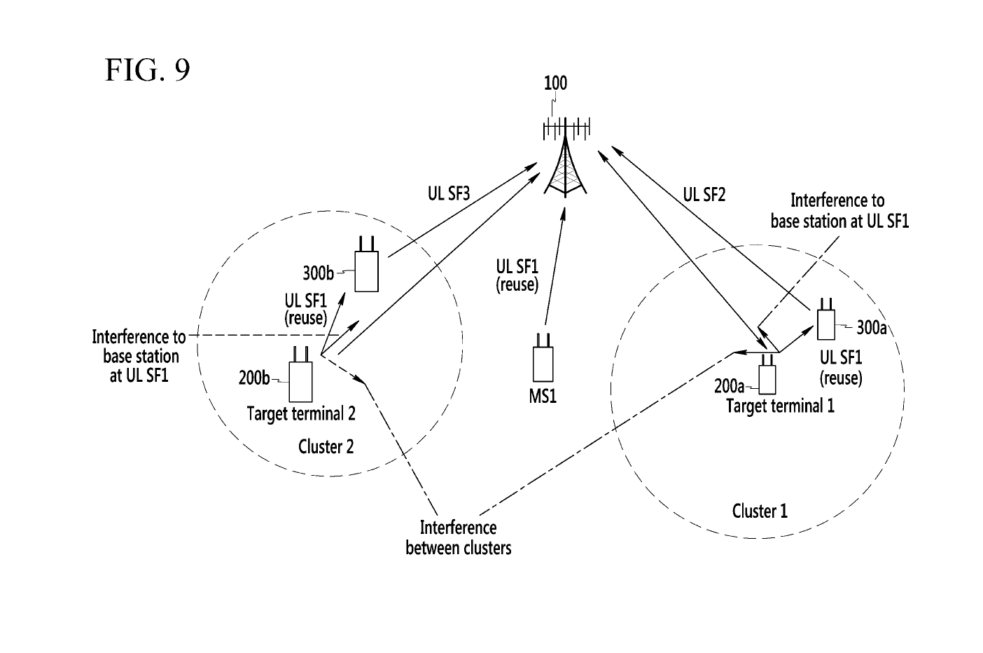

FIG. 9 is a view showing an example where a base station reuses radio resources allocated for uplink cooperative MIMO on the basis of interference.

Referring to FIG. 9, cooperating cluster 1 for target terminal 1 200a includes a cooperating device 300a, and cooperating cluster 2 for target terminal 2 200b includes a cooperating device 300b.

The base station 100 allocates different uplink radio resources to a user terminal MS1, the cooperating cluster 1, and the cooperating cluster 2 to avoid interference between the user terminal MS1, the cooperating cluster 1, and the cooperating cluster 2. For example, the base station 100 may allocate an uplink subframe UL SF1 to the user terminal MS1, another uplink subframe UL SF2 to the target terminal 1 200a of the cooperating cluster 1, and yet another uplink subframe UL SF3 to the target terminal 1 200b of the cooperating cluster 2.

In multi-user MIMO, the same radio resources may be allocated. Multi-user MIMO may also be applied to an exemplary embodiment of the present invention, and a description of multi-user MIMO will be omitted since it will obscure the gist of the invention.

The cooperating cluster 1 and the cooperating cluster 2 are distant from each other, and the transmission power of signals sent from the target terminals 200a and 200b to adjacent cooperating devices 300a and 300b is low. Therefore, the same uplink radio resources may be allocated between the target terminals 200a and 200b and the cooperating devices 300a and 300b within the cooperating clusters 1 and 2, respectively.

Moreover, the signal strength at which signals sent from the cooperating devices 300a and 300b of the cooperating clusters 1 and 2 are received by the base station 100 is much lower than the signal strength at which the user terminal MS1's signal is received by the base station 100. Hence, the same radio resources as the uplink radio resources allocated between the target terminals 200a and 200b and the cooperating devices 300a and 300b within the cooperating clusters 1 and 2 may be allocated for uplink transmission of the user terminal MS1.

That is, the base station 100 may reuse the uplink subframe UL SF1 allocated for transmission from the target terminals 200a and 200b to the cooperating devices 300a and 300b within the cooperating clusters 1 and 2 and allocate it for uplink transmission from the user terminal MS1.

In the above description, the terms “adjacent” and “distant” refer not only to locations in physical space, but also to actual situations where the interfering strength of a radio signal is higher than a threshold value and the interfering strength of the radio signal is lower than the threshold value, respectively.

If signals sent from the target terminals 200a and 200b to the cooperating devices 300a and 300b, respectively, are received at or below a predetermined strength, the base station 100 may allocate the uplink radio resources for transmission of uplink cooperative MIMO signals to other user terminals MS1 to reuse them for uplink transmission. That is, the base station 100 estimates the received strength of uplink cooperative MIMO signals sent from the target terminals 200a and 200b to the cooperating devices 300a and 300b, respectively, and if the received strength is lower than or equal to a predetermined strength, the base station 100 may reuse the uplink radio resources for transmission of uplink cooperative MIMO signals for uplink transmissions from other user terminals (MS1 of FIG. 9).

Moreover, if an uplink cooperative MIMO signal sent from the target terminal 200a to the cooperating device 300a is received at or below a predetermined strength by the cooperating device 300b of the other cooperating cluster, the base station 100 may reuse the uplink radio resource for the uplink cooperative MIMO signal sent from the target terminal 200a to the cooperating device 300a for transmission of an uplink cooperative MIMO signal from the other cooperating cluster.

The target terminals 200a and 200b and the cooperating devices 300a and 300b transmit a discovery ranging signal in a cluster formation procedure, detect a discovery ranging signal sent from other cooperating devices, and report the received signal quality of the discovery ranging signal to the base station 100 through a discovery report message.

The base station 100 may estimate the channel gain between the target terminal 200a or 200b and other user terminals, between the cooperating device 300a or 300b and other user terminals, or between the target terminal 200a or 200b and the cooperating device 300a or 300b, from the transmission power of the discovery ranging signal and the received signal quality of the discovery ranging signal contained in the discovery report message.

If there is no measurement report on the discovery ranging signal between the target terminal 200a or 200b and the cooperating device 300b or 300b of the other cooperating cluster, the base station 100 may approximately estimate the interfering strength, based on a measurement report message in a typical mobile communication system, which is sent by the target terminal 200a or 200b and the cooperating device 300b or 300b of the other cooperating cluster and contains a measurement of the received signal quality of a reference signal received by surrounding base stations.

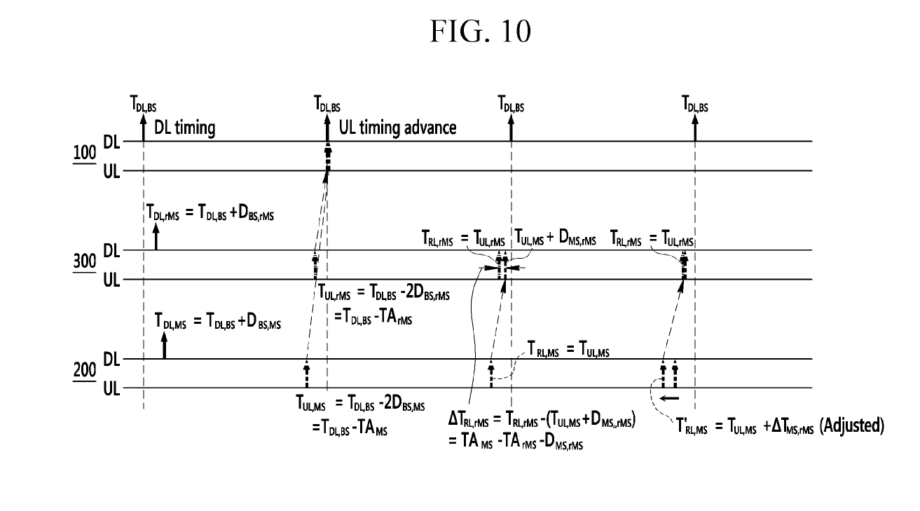

FIG. 10 is a view showing an example of downlink and uplink timings of transmission and reception at a base station, a cooperating device, and a target terminal according to an exemplary embodiment of the present invention.

Referring to FIG. 10, the base station 100 transmits a TA value for reception timing adjustment to the target terminal 200 and the cooperating device 300 as a response to the random access, as explained with reference to FIG. 4. Generally, the base station 100 may set the TA value (TA_{MS}) for the target terminal 200 to 2D_{BS,MS} and set the TA value (TA_{rMS}) for the cooperating device 300 to 2D_{BS,rMS}.

The target terminal 200 and the cooperating 300 adjust the uplink transmission timing to T_{UL,MS}(=T_{DL,BS}−TA_{MS}) and T_{UL,rMS}(=T_{DL,BS}−TA_{rMS}), respectively, depending on the TA values (TA_{MS} and TA_{rMS}).

In the exemplary embodiment of the present invention, the timings of signal transmission and reception between the cooperating device 300 and the target terminal 200, as well as the TA value for synchronized reception at the base station 100, need to be adjusted.

If the target terminal 200 transmits an uplink cooperative MIMO signal to be relayed in uplink at the uplink transmission timing T_{RL,MS}(=T_{UL,MS}) of the target terminal 200, the uplink cooperative MIMO signal reaches the cooperating device 300 at T_{UL,MS}+D_{MS,rMS}. As previously stated, D_{MS,rMS} is the propagation delay between the terminal 200 and the cooperating device 300. There is a time difference Δ T_{rMS}[=T_{UL,rMS}−(T_{UL,MS}+D_{MS,rMS})=TA_{MS}−TA_{rMS}−D_{MS,rMS}] between the reception of the uplink cooperative MIMO signal and the uplink reference timing (T_{RL,rMS}=T_{UL,rMS}) for the cooperating device 300. Methods of adjusting such a time difference include a method for adjusting the timing of the cooperating device 300's reception of the uplink cooperative MIMO signal and a method for adjusting the timing of the target terminal 200's transmission of the uplink cooperative MIMO signal.

For example, referring to FIG. 10, the base station 100 informs the target terminal 200 of a transmission timing offset value Δ T_{RL,rMS} for the uplink cooperative MIO signal. The target terminal 200 adjusts the transmission timing by applying Δ T_{RL,rMS} to the uplink reference timing (T_{RL,MS}=T_{UL,MS}) for the target terminal 200, and transmits the uplink cooperative MIMO signal at the transmission timing T′_{RL,MS}(=T_{UL,MS}−Δ T_{RL,rMS}).

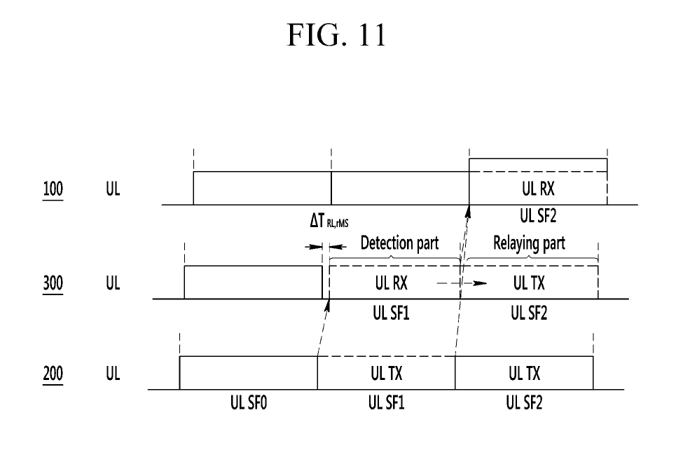

FIG. 11 is a view showing a method for adjusting the reception timing of a target terminal's uplink cooperative MIMO signal in a cooperating device according to an exemplary embodiment of the present invention.

Referring to FIG. 11, without transmission timing adjustment, the target terminal 200 transmits an uplink cooperative MIMO signal at its start time of an uplink subframe UL SF1, i.e., the uplink reference timing for the target terminal 200.

There is a time difference Δ T_{RL,rMS}[=TA_{MS}−TA_{rMS}−D_{MS,rMS}] between the cooperating device 300's reception of the uplink cooperative MIMO signal and the uplink reference timing for the cooperating device 300.

If the cooperating device 300 is aware of the time difference Δ T_{RL,rMS}, the uplink cooperative MIMO signal may be detected using reception synchronization. Such the time difference Δ T_{RL,rMS} may be informed from the base station 100 to the target terminal 200 through a cluster configuration message in a cluster formation procedure or through a discovery command message.

In a cooperating cluster formation procedure, the target terminal 200 or the cooperating device 300 measures a difference Δ Tₘₛ[=TA_{rMS}−TA_{MS}−D_{MS,rMS}] or Δ T_{rMS}[=TA_{MS}−TA_{rMS}−D_{MS,rMS}] in detecting the discovery ranging signal and reports it to the base station 100.

Since the base station 100 is aware of uplink timing offset values TA_{MS} and TA_{rMS} for the target terminal 200 and the cooperating device 300, it may calculate the propagation delay D_{MS,rMS} between the target terminal 200 and the cooperating device 300 based on the report of discovery ranging signal detection timing.

The base station 100 calculates a reception timing offset value Δ T_{RL,rMS} based on the uplink timing offset values TA_{MS} and TA_{rMS} for the target terminal 200 and the cooperating device 300 and the propagation delay D_{MS,rMS} between the target terminal 200 and the cooperating device 300, and informs the reception timing offset value Δ T_{RL,rMS} to the cooperating device 300 through a cluster configuration message in a cooperating cluster formation procedure or through a discovery command message.

In FIG. 11, the cooperating device 300 receives an uplink cooperative MIMO signal after the elapse of the reception timing offset value Δ T_{RL,rMS} since its starting time of uplink subframe UL SF1. The detection part during which the cooperating device 300 receives the uplink cooperative MIMO signal from the target terminal 200 corresponds the duration from the reception timing offset after uplink subframe UL SF1 (T_{UL,rMS} of UL SF1+Δ T_{RL,rMS}) to a time before the end of the uplink subframe UL SF1 (T_{UL,rMS} of UL SF2−T_{SW}). Where T_{SW} is a RX/TX switching time duration between the reception of the uplink cooperative MIMO signal and the transmission of the uplink signal at cooperating device 300. That is, denoting an uplink subframe duration to T_{sf}, the time duration of detection part corresponds to T_{sf}−Δ T_{RL,rMS}−T_{SW}. The cooperating device 300 amplifies the detection part of the uplink cooperative MIMO signal and transmits it in the uplink subframe UL SF2. The duration of relaying part which the cooperating device 300 transmits in the uplink subframe UL SF2 is same as the duration of detection part (T_{sf}−Δ T_{RL,rMS}−T_{SW}).

If, in the uplink subframe UL SF2, the cooperating device 300′ relaying is not allocated (that is, the cooperating device 300′ relaying is allocated in another subframe) and there is no uplink allocation for the cooperating device 300, the cooperating device can receive the target 200's uplink cooperative MIMO signal in the entire uplink subframe duration (T_{sf}) because the RX/TX switching time is not required and it can receive the uplink cooperative MIMO signal in UL SF2.

While FIG. 11 illustrates an example where the cooperating device 300 receives an uplink cooperative MIMO signal later than the uplink reference timing, but the uplink cooperative MIMO signal may be received earlier than the uplink reference timing depending on the locations of the cooperating device 300 and the target terminal 200.

If there is an uplink signal transmission UL TX in an uplink subframe UL SF0 in front of the uplink subframe UL SF1 in which the cooperating device 300 receives an uplink cooperative MIMO signal, the cooperating device 300 receives the uplink cooperative MIMO signal after the uplink signal transmission is completed. When the uplink cooperative MIMO signal arrives earlier than the uplink reference timing for the cooperating device 300 and the cooperating device 300 receives the uplink cooperative MIMO signal after transmitting its uplink signal, a front portion of the uplink cooperative MIMO signal may not be received. Therefore, the relaying part transmitted in the uplink subframe UL SF2 may not include the whole uplink cooperative MIMO signal in the uplink subframe UL SF1.

The above method for adjusting the reception timing of the target terminal 200's uplink cooperative MIMO signal in the cooperating device 300 involves the target terminal 200's transmitting the uplink cooperative MIMO signal based on its own uplink reference timing. In this method, the target terminal 200 may transmit an uplink cooperative MIMO signal for the duration of an uplink subframe, whereas the cooperating device 300 may receive the uplink cooperative MIMO signal during the time left after subtracting a certain amount of time from the original duration of the uplink subframe.

Although uplink cooperative MIMO signal reception during that subtracted amount of time results in losses of signal energy and data, these losses may be overcome by adjusting the coding rate and modulation scheme of cooperative MIMO signals.

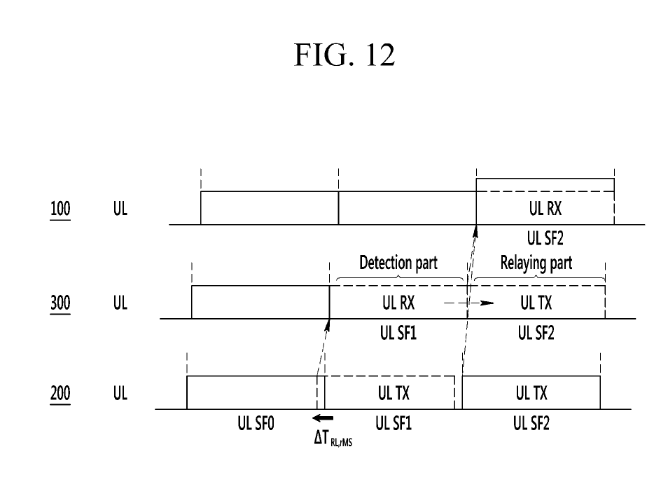

FIG. 12 is a view for explaining a method for adjusting the transmission timing of an uplink cooperative MIMO signal in a target terminal according to an exemplary embodiment of the present invention.

As with the adjustment of reception timing shown in FIG. 11, in a cooperating cluster formation procedure, the target terminal 200 or the cooperating device 300 measures a difference ΔT_{MS}[=TA_{rMS}−TA_{MS}—D_{MS,rMS}] or Δ T_{rMS}[=TA_{MS}−TA_{rMS}−D_{MS,rMS}] in discovery ranging signal reception timing and reports it to the base station 100.

The base station 100 informs the cooperating device 300 of a transmission timing offset value Δ T_{RL,rMS} for an uplink cooperative MIMO signal, calculated based on the difference Δ T_{Ms} or Δ T_{rMS} in discovery ranging signal reception timing, through a cluster configuration message in a cooperating cluster formation procedure or through a discovery command message.

The target terminal 200 adjusts the transmission timing by applying Δ T_{RL,rMS} to its start time of an uplink subframe UL SF1, i.e., the uplink reference timing for the target terminal 200, and transmits the uplink cooperative MIMO signal to the cooperating device 300 at the transmission timing T′_{RL,MS} [=T_{UL,MS}−Δ T_{RL,rMS}].

The uplink cooperative MIMO signal transmitted from the target terminal 200 is received in synchronization with its start time of the uplink subframe UL for the cooperating device 300, i.e., the uplink reference timing T_{UL,rMS} for the cooperating device 300.

If there is another uplink signal transmission (but not cooperative MIMO transmission) in an uplink subframe UL SF0 in front of the uplink subframe UL SF1, the target terminal 200 transmits the uplink cooperative MIMO signal after the uplink signal transmission is completed. In this case, if the original duration of the uplink subframe UL SF1 is denoted by T_{sf}, the transmission part of the uplink cooperative MIMO signal at the target terminal 200 is reduced to (T_{sf}−Δ T_{RL,rMS}).

If the cooperating device 300 transmits an uplink signal transmission in the uplink subframe UL SF0 in front of the uplink subframe UL SF1, the cooperating device 300 receives the uplink cooperative MIMO signal after the elapse of the transmission/reception switching time T_{SW} since its start time of the uplink subframe UL SF1. That is, the detection part of the uplink cooperative MIMO signal is reduced from the original duration T_{sf} of the uplink subframe UL SF1 to (T_{sf}−T_{SW}) if the target terminal 200 transmits the uplink cooperative MIMO signal in the whole subframe duration, or to (T_{sf}−Δ T_{RL,rMS}−T_{SW}) if not.

If there is an uplink signal transmission in the uplink subframe UL SF2 after the uplink subframe UL SF1, the cooperating device 300 receives the uplink cooperative MIMO signal until a time corresponding to before the transmission/reception switching time T_{SW} from its start time of the uplink subframe UL SF2. That is, the detection part of the uplink cooperative MIMO signal may be reduced from the whole subframe duration T_{sf} of the subframe to (T_{sf}−T_{SW}) if the target terminal 200 transmits the uplink cooperative MIMO signal in the whole subframe duration and the cooperative device 300 does not have any another transmission at the uplink subframe UL SF0, to (T_{sf}−Δ T_{RL,rMS}−T_{SW}) if the target terminal 200 does not transmit the uplink cooperative MIMO signal in the whole subframe duration and the cooperative device 300 does not have any another transmission at the uplink subframe UL SF0, or to (T_{sf}−Δ T_{RL,rMS}−2T_{SW}) if the target terminal 200 does not transmit the uplink cooperative MIMO signal in the whole subframe duration and the cooperative device 300 has any another transmission at the uplink subframe UL SF0.

As stated above, if there are uplink signal transmissions in the previous and next frames, the cooperating device 300 receives the uplink cooperative MIMO signal during the reduced period. If there is no uplink signal transmission in either the previous frame or the next frame, the cooperating device 300 may receive the uplink MIMO signal during the entire duration T_{sf} of the subframe.

In the above method for adjusting the timing of the target terminal 200's transmission of the uplink cooperative MIMO signal, the target terminal 200 may transmit the uplink cooperative MIMO signal during the time left after subtracting a certain amount of time from the original duration of the uplink subframe, and the cooperating device 300 may receive the uplink cooperative MIMO signal during the time left after subtracting a certain amount of time from the original duration of the uplink subframe. Although uplink cooperative MIMO signal transmission and reception during that subtracted amount of time results in losses of signal energy and data, these losses may be overcome by adjusting the coding rate and modulation scheme of cooperative MIMO signals to compensate for the losses.

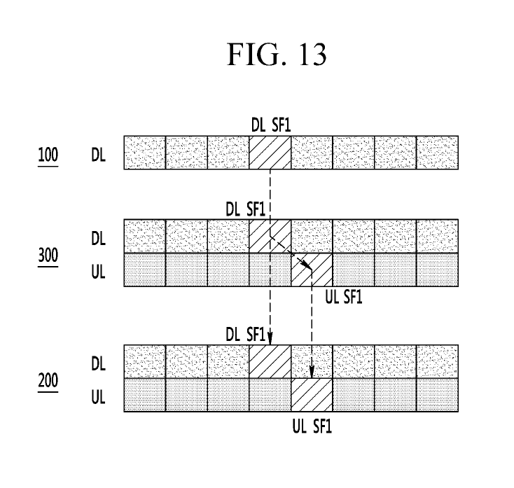

FIG. 13 is a view showing an example of radio resources used for downlink cooperative MIMO according to an exemplary embodiment of the present invention.

Referring to FIG. 13, a base station 100 transmits a downlink MIMO signal to a target terminal 200 on downlink (DL) radio resources in a downlink subframe DL SF1.

A cooperating device 300 receives the downlink MIMO signal from the base station 100 in the downlink subframe DL SF1 from the base station 100, and amplifies the downlink MIMO signal and relays it to the target terminal 200 on uplink radio resources in an uplink subframe UL SF1 allocated by the base station 100.

The target terminal 200 receives the downlink MIMO signal from the base station 100 in the downlink subframe DL SF1, receives the downlink MIMO signal relayed by the cooperating device 300 in the uplink subframe UL SF1, and combines these signals.

The target terminal 200 assumes that the received signal relayed in uplink UL by the cooperating device 300 is received by virtual additional antennas, aside from the antennas originally equipped in the target terminal 200, and performs signal detection.

A downlink signal received directly from the base station 100 and a downlink signal relayed by the cooperating device 300 are received by the same antenna of the target terminal 200, but these two types of signals are received in different radio resources through different physical paths. Accordingly, the target terminal 200 may detect a MIMO signal, which can be received using a larger number of antennas than the number of receive antennas at the target terminal 200.

For example, if the target terminal 200 receives a signal by n receive antennas and (r−1) cooperating devices 300 relay a downlink signal in uplink, the target terminal 200 may detect a signal using (n×r) receive antennas. Accordingly, if the base station 100 performs MIMO transmission by m transmit antennas and m≧n×r, the base station 100 may transmit a maximum of (n×r) data streams or layers in downlink to the target terminal 200. Thus, the target terminal 200 may receive more than n data streams or layers, which is the maximum number allowed by the target terminal 200's antennas.

As such, the target terminal 200 is able to transmit an additional signal through the medium of cooperating devices 300 by using uplink (UL) radio resources. Hence, the rate of data transfer to the target terminal 200 increases linearly in proportion to the number of cooperating devices 300 and the amount of radio resources used.

The uplink (UL) radio resources the cooperating devices 300 have used for relaying may be reused for relay transmissions from other cooperating clusters far away from the current cluster, causing less interference, or for uplink transmissions from other terminals. Accordingly, cooperative MIMO transmission with higher transmission capacity from the target terminal 200 can be achieved without a decrease in cell capacity caused by the use of radio resources for relaying, and the transmission capacity of the cell increases.

FIG. 13 illustrates radio resources on a FDD basis, and the cooperative MIMO transmission method and procedure according to the exemplary embodiment of the present invention are also applicable on a TDD basis.

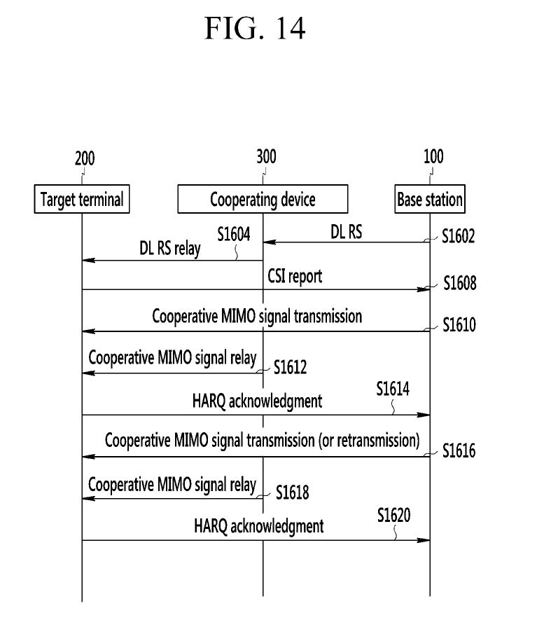

FIG. 14 is a view showing an example of a downlink signal transmission method for downlink cooperative MIMO according to an exemplary embodiment of the present invention.

Referring to FIG. 14, downlink cooperative MIMO transmission refers to MIMO transmission and reception that uses one or more downlink signals relayed by one or more cooperating devices 300, as well as the downlink signal sent directly from a base station 100 to a target terminal 200. In order for the base station 100 to select an appropriate MIMO transmission scheme and precoding scheme for the target terminal 200, the target terminal 200 needs to estimate the channel state information (CSI) of a combined channel for two types of signals and report it to the base station 100 by using the base station 100's reference signal relayed by the cooperating device 300, as well as a reference signal received directly from the base station 100.

One or more cooperating devices 300 receive and amplify a signal sent from the base station 100 in a downlink subframe and relay the amplified signal in an uplink subframe, as instruction information in a cluster formation procedure or as instruction information of a downlink control channel. The relayed signal may include a reference signal alone. The relayed signal may be transmitted using all radio resources in the uplink subframe. If multiple cooperating devices 300 relay a signal, they may receive and amplify the signal in the same downlink subframe, and relay the signal in different uplink subframes.

The base station 100 transmits a reference signal DL (S1602).

The cooperating device 300 receives the reference signal DL RS from the base station 100 in a downlink subframe, and amplifies and relays it to the target terminal 200 in an uplink subframe (S1604).

The target terminal 200 receives reference signals from the base station 100 and relayed by the cooperating device 300, and estimates the channel state information (CSI) of a combined channel for the two reference signals.

The target terminal 200 reports the CSI estimate to the base station 100 through a CSI report message or over an uplink physical channel (in the case of an LTE system, PUCCH or PUSCH) (S1608). The CSI reporting and what CSI contains are identical to the CSI reporting for general MIMO where, if the target terminal 200 receives a signal by n receive antennas and (r−1) cooperating devices 300 relay it, the target terminal 200 uses (n×r) receive antennas.

For example, if the target terminal 200 uses a transmit antenna 1 and a transmit antenna 2 and one cooperating device 300 cooperates with the target terminal 200, the target terminal 200 receives a reference signal 1 directly from the base station 100 by the receive antenna 1 and the receive antenna 2, and receives a reference signal 2 relayed by the cooperating device 300 by the receive antenna 1 and the receive antenna 2. In this case, the target terminal 200 receives the reference signal 2 by virtual receive antennas 3 and 4 corresponding to the receive antennas 1 and 2.

The reference signals 1 and 2 are the same signals sent from the base station 100 by transmit antennas. The target terminal 200 assumes that the reference signal 1 and reference signal 2 are reference signals received by the receive antennas 1, 2, 3, and 4 of the target terminal 200, and estimates CSI.

As instructed in a cluster configuration message or according to a downlink control channel command, the cooperating device 300 may periodically relay the base station 100's downlink signal in uplink, and the target terminal 200 may receive the base station 100's reference signal DL RS received in downlink and the base station 100's reference signal relayed in uplink, estimate CSI, and periodically report the CSI to the base station 100.

The downlink subframe used for relaying for CSI estimation may be identical to the downlink subframe used for cooperative MIMO signal transmission in which data is carried to the target terminal 200.

In the transmission of data to the target terminal 200 after initial reference signal reception and CSI estimation and reporting, if a downlink subframe for data transmission to the target terminal 200 contains a reference signal, the process of relaying the base station 100's reference signal for CSI estimation may be used only for initial data transmission and omitted in subsequent data transmissions.

Similarly to general MIMO transmission, the base station 100 schedules an open-loop or closed-loop, spatial multiplexing or spatial diversity MIMO data transmission to the target terminal 200 according to the CSI report.

The base station 100 informs the target terminal 200 of a downlink cooperative MIMO transmission over a downlink control channel (in the case of LTE, PDCCH) and transmits a cooperative MIMO signal in downlink (S1610).

The cooperating device 300 receives the cooperative MIMO signal sent from the base station 100 to the target terminal 200 in a downlink subframe, and amplifies the cooperative MIMO signal and relays it to the target terminal in an uplink subframe (S1612).

The base station 100 may provide the cooperating device 300 with the position of the downlink subframe where the base station 100 uses to transmit to the target terminal 200 over a downlink control channel. The base station 100 may specify the position of the downlink subframe and inform the cooperating device 300 of the position through a cluster configuration message in a cluster formation procedure. The base station 100 may provide the cooperating device 300 with the position of the uplink subframe the cooperating device 300 uses to relay the signal to the target terminal 200 over a downlink control channel. The base station 100 may specify the position of the uplink subframe and inform the cooperating device 300 of the position through a cluster configuration message in a cluster formation procedure.

A cooperative MIMO signal relayed to the base station 100 by the cooperating device 300 may include the entire downlink subframe in which the cooperative MIMO signal is transmitted, or may include only the signal in a radio resource allocated for the target terminal 200.

The position of a downlink subframe used for relaying may be represented by a periodical index. The index of a downlink subframe used for transmitting a cooperative MIMO signal to the target terminal 200 may be identical to the index of a downlink subframe used for relaying the base station's reference signal DL RS for CSI estimation by the target terminal 200. That is, the base station 100's reference signal DL RS may be relayed at the same interval and the same position as the cooperative MIMO signal is transmitted for the target terminal 200. In this case, the corresponding downlink subframe may include both the reference signal DL RS and the cooperative MIMO signal.

The target terminal 200 receives and combines the cooperative MIMO signal from the base station 100 and the cooperative MIMO signal relayed in uplink from the cooperating device 300, and demodulates data from the combined signals.

The target terminal 200 sends feedback about the success or failure of the demodulation attempt to the base station 100 as a HARQ acknowledgment (S1614). If the demodulation attempt is successful, the target terminal 200 transmits a positive acknowledgment ACK to the base station 100, or if the demodulation attempt fails, the target terminal 200 transmits a negative acknowledgment NACK to the base station 100.

If the HARQ acknowledgment is negative NACK, the base station 100 retransmits HARQ (S1616).

On the contrary, if the HARQ acknowledgment is positive ACK, the base station 100 transmits a cooperative MIMO signal for new data (S1616).

The cooperating device 300 receives a cooperative MIMO signal sent to a specified target terminal 200 through a cluster configuration message or over a downlink control channel, regardless of whether an initial HARQ transmission or HARQ retransmission, and amplifies the received signal and relays it to the target terminal 200 (S1618).

The target terminal 200 receives and combines the cooperative MIMO signal from the base station 100 and the cooperative MIMO signal relayed in uplink from the cooperating device 300, demodulates data from the combined signals, and reports the success or failure of the demodulation attempt to the base station 100 as a HARQ acknowledgment (S1620).

Multi-user MIMO may be used for the base station 100 to transmit the target terminal 200's cooperative MIMO signal. That is, cooperative MIMO signals transmitted for different cooperating clusters may be transmitted in the same radio resources by different precoding strategies. Moreover, MIMO signals sent to other terminals and cooperative MIMO signals transmitted for a cooperating cluster may be transmitted in the same radio resources by different precoding strategies.

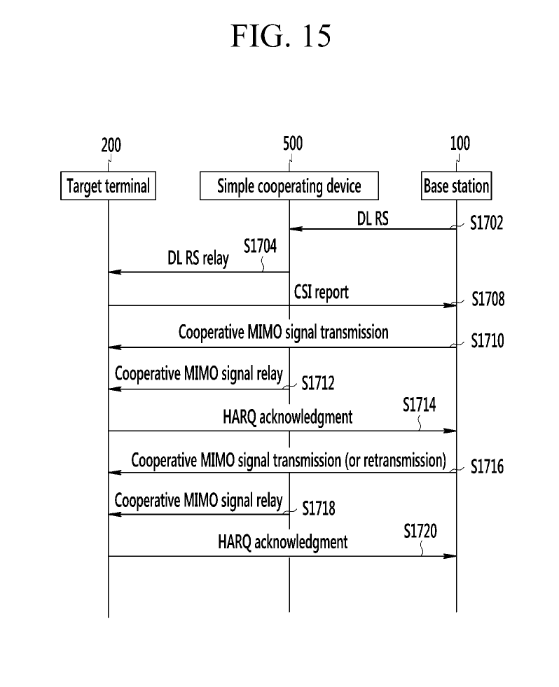

FIG. 15 is a view showing another example of a downlink signal transmission method for downlink cooperative MIMO according to an exemplary embodiment of the present invention.

Referring to FIG. 15, a simple cooperating device 500 is one that is pre-installed by the administrator or the user. A downlink subframe to be received by the simple cooperating device 500 and an uplink subframe for relaying may be specified at regular intervals. The simple cooperating device 500 is a cooperating device that is configured to receive a signal in a specified downlink subframe and amplify and forward the received signal in a specified uplink subframe, without having to know which cluster for which target terminal 200 it belongs to, which downlink subframe it receives depending on the target terminal 200, and in which uplink subframe the signal is amplified and forwarded to the target terminal 200. As a downlink subframe to be received by the simple cooperating device 500 and an uplink subframe for relaying are specified, the downlink signal transmission process for downlink cooperative MIMO shown in FIG. 14 may be simplified by using the simple cooperating device 500. The detailed description on downlink signal transmission process S1702 to S1720 for downlink cooperative MIMO shown in FIG. 15 is omitted since it is identical to the downlink signal transmission process S1602 to S1620 shown in FIG. 14. The simple cooperating device 500 may be the simple cooperating device 300′ of FIG. 3 or other devices.

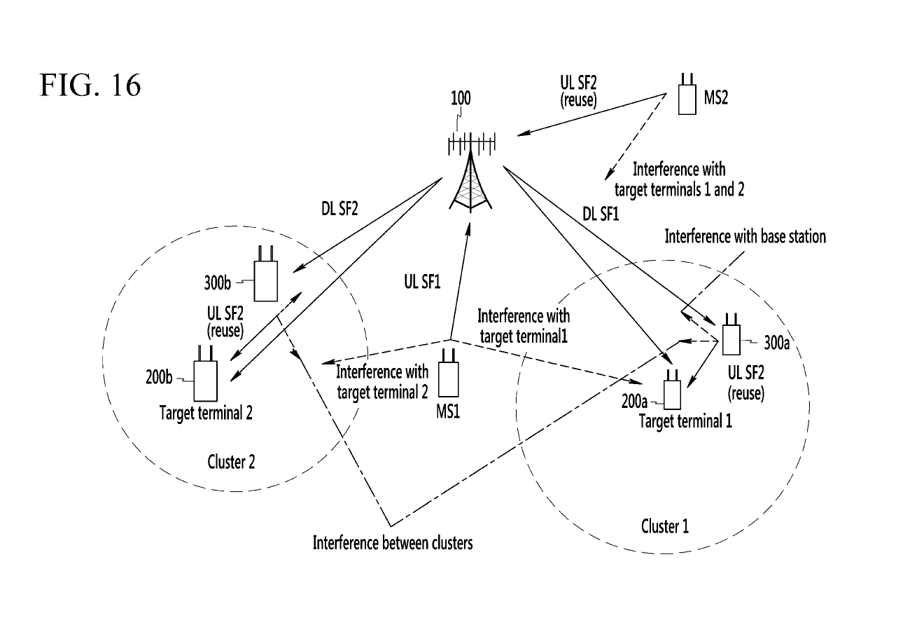

FIG. 16 is a view showing an example where a base station reuses radio resources allocated for downlink cooperative MIMO depending on interference.

Referring to FIG. 16, cooperating cluster 1 for target terminal 1 200a includes a cooperating device 300a, and cooperating cluster 2 for target terminal 2 200b includes a cooperating device 300b.

The base station 100 transmits a cooperative MIMO signal to the target terminal 1 200a in a downlink subframe DL SF1, and transmits a cooperative MIMO signal to the target terminal 2 200b in a downlink subframe DL SF2.

The cooperating devices 300a and 300b receive the cooperative MIMO signals in the downlink subframes DL SF1 and DL SF2, respectively, and amplify them, and relay the amplified signals to the target terminal 1 200a and the target terminal 2 200b in an uplink subframe UL.

The base station 100 may allocate the same uplink subframe UL SF2 to the cooperating devices 300a and 300b for relaying, on the basis of interference between signals respectively relayed by the cooperating devices 300a and 300b. That is, the base station 100 may estimate the interfering strength received by the target terminal 200b or 200a of the other cooperating cluster 300b or 300a when the cooperating device 300a or 300b of each cooperating cluster relays a signal, and allocate the same uplink subframe UL SF2 to the cooperating devices 300a and 300b on the basis of the interfering strength.

If the estimated interfering strength is lower than a predetermined value, the base station 100 allocates the same uplink radio resource UL SF2 to the cooperating devices 300a and 300b for relaying between the cooperating cluster 1 and the cooperating cluster 2.

Moreover, the base station 100 estimates the received signal quality of signals relayed by the cooperating devices 300a and 300b and received by the target terminals 200a and 200b, respectively, and if the estimated received signal quality is higher than a predetermined value, the base station 100 may allocate the same uplink radio resource UL SF2 to the cooperating devices 300a and 300b for relaying between the cooperating cluster 1 and the cooperating cluster 2.

If the interfering strength received by the target terminal 200b or 200a of the other cooperating cluster 300b or 300a is higher than or equal to a predetermined value, or the received signal quality of a signal relayed by the cooperating device 300a or 300b and received by each target terminal 200a or 200b is lower than or equal to a predetermined value, the base station 100 may allocate different uplink subframes for relaying to the cooperating devices 300a and 300b.

Meanwhile, the base station 100 may allocate, to a user terminal MS1, the same uplink subframe UL SF2 used for relaying by the cooperating devices 300a and 300b. The user terminal MS1 is adjacent to the target terminal 1 200a and the target terminal 2 200b, and this may cause severe interference when the target terminals 1 200a and 2 200b receive a relayed signal. Accordingly, the base station 100 allocates an uplink radio resource UL SF1, different from the radio resource, i.e., uplink subframe UL SF2 used for relaying, to the user terminal MS1 adjacent to the target terminal 1 200a and the target terminal 2 200b.

On the contrary, a user terminal MS2 is far apart from the target terminal 1 200a and the target terminal 2 200b, and an uplink signal from the user terminal MS2 causes weak interference with the target terminal 1 200a and the target terminal 2 200b. Accordingly, the base station 100 may allocate the same uplink subframe UL SF2 allocated for relaying to the user terminal MS2 which is far apart from the target terminal 1 200a and the target terminal 2 200b.

The base station 100 estimates the received strength of signals relayed by the cooperating devices 300a and 300b, and if the received strength is lower than or equal to a predetermined strength, the base station 100 may reuse the uplink radio resources for relaying for uplink transmissions from other user terminals (MS2 of FIG. 8).

Also, the base station 100 estimates the received signal quality of uplink cooperative MIMO signals from other user terminals MS2 received by the base station 100, based on the received strength of signals relayed by the cooperating devices 300a and 300b, and if the received signal quality is higher than or equal to a predetermined value, the base station 100 may reuse the uplink radio resources for relaying for uplink transmissions from other user terminals.

The base station 100 estimates the received strength of uplink signals from other user terminals (MS1 and MS2 of FIG. 16) received by the target terminals 200a and 200b. If the estimated received strength is lower than or equal to a predetermined strength, or the received signal quality of signals relayed by the cooperating devices 300a and 300b and received by the target terminals 200a and 200b is higher than or equal to a predetermined value, the base station 100 may allocate the uplink radio resources for relaying to other user terminals to reuse them for uplink transmission.

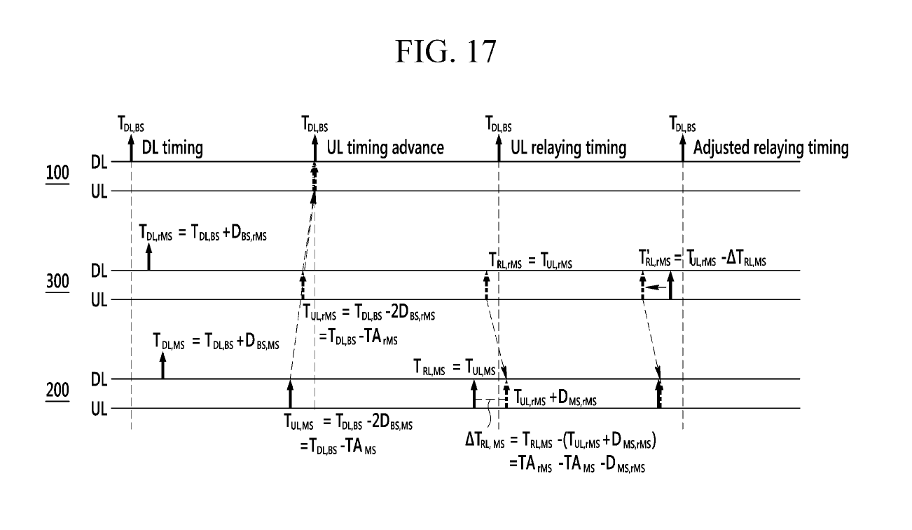

FIG. 17 is a view showing an example of downlink and uplink timings of transmission and reception at a base station, a cooperating device, and a target terminal according to an exemplary embodiment of the present invention.

Referring to FIG. 17, the base station 100 transmits a TA value for reception timing adjustment to the target terminal 200 and the cooperating device 300 as a response to the random access, as explained with reference to FIG. 4. Generally, the base station 100 may set the TA value (TA_{MS}) for the target terminal 200 to 2D_{BS,MS} and set the TA value (TA_{rMS}) for the cooperating device 300 to 2D_{BS,rMS}.

The target terminal 200 and the cooperating 300 adjust the uplink transmission timing to T_{UL,rMS}(=T_{DL,BS}−TA_{rMS}) and T_{UL,MS}(=T_{DL,BS}−TA_{MS}), respectively, depending on the TA values (TA_{MS} and TA_{rMS}).

In the exemplary embodiment of the present invention, the timings of signal transmission and reception between the cooperating device 300 and the target terminal 200, as well as the TA value for synchronized reception at the base station 100, needs to be adjusted.

If the cooperating device 300 transmits a signal (hereinafter, referred to as a “relay signal”) received from the base station 100 at the transmission timing (T_{RL,rMS}=T_{UL,rMS}) of the cooperating device 300, the signal reaches the target terminal 200 at T_{UL,rMS}+D_{MS,rMS}. As explained above, D_{MS,rMS} is the propagation delay between the terminal 200 and the cooperating device 300. There is a time difference Δ T_{RL,MS} [=T_{RL,MS}−(T_{UL,rMS}+D_{MS,rMS})=TA_{rMS}−TA_{MS}−D_{MS,rMS}] between the target terminal 200's reception of the relay signal and the uplink reference timing (T_{RL,MS}=T_{UL,MS}) for the target terminal 200. Methods of adjusting such a time difference include a method for adjusting the timing of the target terminal 200's reception of the relay signal and a method for adjusting the timing of the cooperating device 300's transmission of the relay signal.

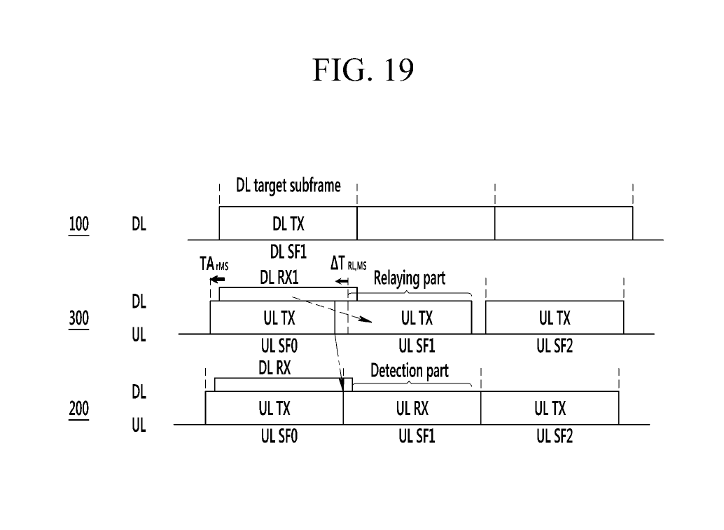

FIG. 17 illustrates a method for adjusting the timing of the cooperating device 300's transmission of the relay signal. Specifically, the base station 100 informs the cooperating device 300 of a transmission timing offset value Δ T_{RL,MS} for the relay signal. The cooperating device 300 adjusts the transmission timing by applying Δ T_{RL,MS} to its uplink reference timing (T_{RL,MS}=T_{UL,MS}), and transmits the relay signal in uplink at the transmission timing T_{RL,rMS}(=T_{UL,rMS}−Δ T_{RL,MS}). A detailed description of this will be given with reference to FIG. 19.

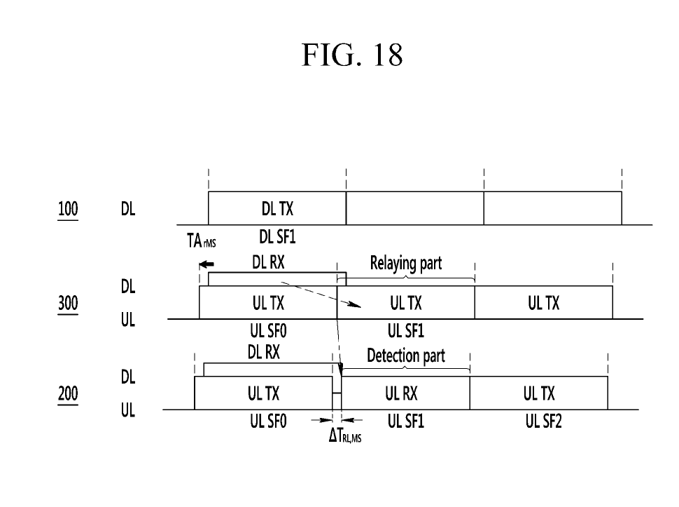

FIG. 18 is a view showing a method for adjusting the timing of a target terminal's reception of a cooperating device's relay signal according to an exemplary embodiment of the present invention.

Referring to FIG. 18, the base station 100 transmits a downlink MIMO signal at its start time of a downlink subframe DL SF1.

The cooperating device 300 receives a downlink MIMO signal from the base station 100 in the downlink subframe DL SF1, amplifies the received downlink MIMO signal, and relays it at the start time of an uplink subframe UL SF1, i.e., the uplink reference timing for the cooperating device 300 during the relaying part of the uplink subframe UL SF1.

There is a time difference Δ T_{RL,MS}[=TA_{rMS}−TA_{MS}−D_{MS,rMS}] between the target terminal 200's reception of the relay signal and the start of an uplink subframe UL SF1.

If the target terminal 200 is aware of the time difference Δ T_{RL,MS}, the relay signal may be detected using reception synchronization. Such the time difference Δ T_{RL,MS} in reception timing may be informed from the base station 100 to the target terminal 200 through a cluster configuration message in a cluster formation procedure or through a discovery command message.

In a cooperating cluster formation procedure, the target terminal 200 or the cooperating device 300 measures a difference Δ T_{MS}[=TA_{rMS}−TA_{MS}−D_{MS,rMS}] or Δ T_{rMS}[=TA_{MS}−TA_{rMS}−D_{MS,rMS}] in detecting the discovery ranging signal and reports it to the base station 100.

Since the base station 100 is aware of uplink timing offset values TA_{MS} and TA_{rMS} for the target terminal 200 and the cooperating device 300, it may calculate the propagation delay D_{MS,rMS} between the target terminal 200 and the cooperating device 300 based on the report of discovery ranging signal detection timing.

The base station 100 calculates a reception timing offset value Δ T_{RL,MS} based on the uplink timing offset values TA_{MS} and TA_{rMS} for the target terminal 200 and the cooperating device 300 and the propagation delay D_{MS,rMS} between the target terminal 200 and the cooperating device 300, and informs the reception timing offset value Δ T_{RL,MS} to the target terminal 200 through a cluster configuration message in a cooperating cluster formation procedure or through a discovery command message.

The target terminal 200 receives a relay signal after the elapse of the reception timing offset value Δ T_{RL,MS} since its starting time of the uplink subframe UL SF1 for the target terminal 200. The detection part during which the target terminal 200 receives the relay signal from the cooperating device 300 corresponds the duration from the reception timing offset after uplink subframe UL SF1 (T_{UL,rMS} of UL SF1+ΔT_{RL,MS}) to a time before the end of the uplink subframe UL SF1 (T_{UL,MS} of UL SF2−T_{SW}). Where T_{SW} is a RX/TX switching time duration between the reception of the relay signal and the transmission of the uplink signal at the target terminal 200. That is, denoting an uplink subframe duration to T_{sf}, the time duration of detection part corresponds to T_{sf}−ΔT_{RL,MS}−T_{SW}.

If, in the uplink subframe UL SF2, the uplink signal is not allocated (that is, the uplink signal is allocated in another subframe) and there is no uplink allocation for the target terminal 200, the target terminal 200 can receive the relay signal in the entire uplink subframe duration (T_{sf}) because the RX/TX switching time is not required and it can receive the relay signal in UL SF1.

While FIG. 18 illustrates an example where the target terminal 200 receives a relay signal later than the uplink reference timing, the relay signal may be received earlier than the uplink reference timing depending on the locations of the cooperating device 300 and the target terminal 200.

If there is an uplink signal transmission from the target terminal 200 in an uplink subframe UL SF0 in front of the uplink subframe UL SF1, the target terminal 200 receives the relay signal after the uplink signal transmission is completed. When the relay signal arrives earlier than the uplink reference timing for the target terminal 200 and the target terminal 200 receives the relay signal after transmitting its uplink signal, a front portion of the relay signal may not be received. Therefore, the relaying part transmitted in SF1 may not include the whole relay signal.

The above method for adjusting the reception timing of the relay signal in the target terminal 200 involves the cooperating device 300's transmitting the relay signal based on its own uplink reference timing. In this method, the cooperating device 300 may transmit a relay signal for the duration of an uplink subframe, whereas the target terminal 200 may receive the relay signal during the time left after subtracting a certain amount of time from the original duration of the uplink subframe.

Although relay signal reception during that subtracted amount of time results in losses of signal energy and data, these losses may be overcome by adjusting the coding rate and modulation scheme of cooperative MIMO signals.

FIG. 19 is a view for explaining a method for adjusting the timing of a cooperating device's transmission of a relay signal according to an exemplary embodiment of the present invention.

As with the adjustment of reception timing shown in FIG. 18, in a cooperating cluster formation procedure, the target terminal 200 or the cooperating device 300 measures a difference ΔT_{MS}[=TA_{rMS}−TA_{MS}—D_{MS,rMS}] or Δ T_{rMS}[=TA_{MS}−TA_{rMS}−D_{MS,rMS}] in discovery ranging signal reception timing and reports it to the base station 100.

The base station 100 informs the cooperating device 300 of a transmission timing offset value Δ T_{RL,MS} for a relay signal, calculated based on the difference Δ T_{Ms} or Δ T_{rMS} in discovery ranging signal reception timing, through a cluster configuration message in a cooperating cluster formation procedure or through a discovery command message.

The base station 100 transmits a downlink MIMO signal at its start time of a downlink subframe DL SF1.

The cooperating device 300 receives a downlink MIMO signal from the base station 100 during a downlink subframe DL SF1, amplifies the received signal, adjusts the transmission timing by applying Δ T_{RL,MS} to its start time of an uplink subframe UL SF1, and relays the amplified signal during the relaying part at transmission timing T′_{RL,rMS} [=T_{UL,rMS}−Δ T_{RL,MS}].

The relay signal is received by the target terminal 200 in synchronization with the uplink reference timing T_{UL,MS} for the target terminal 200.

If there is an uplink signal transmission in an uplink subframe UL SF0 in front of the uplink subframe UL SF1, the cooperating device 300 transmits the relay signal after the uplink signal transmission is completed. In this case, if the duration of the uplink subframe UL SF1 is denoted by T_{sf}, the relaying part of the relay signal at the cooperating device 300 is reduced to the period (T_{sf}−Δ T_{RL,MS}).

As with the adjustment of reception timing shown in FIG. 18, the target terminal 200 sets a detection part by one of the following two methods, when receiving and combining a downlink MIMO signal and a relay signal.

The first method is to receive a relay signal after receiving a downlink MIMO signal. The downlink MIMO signal reception is completed after the elapse of TA_{MS} since its start of the uplink subframe UL SF1, so a front portion of the relay signal corresponding to TA_{MS} may not be received. That is, the period between the end of the TA_{MS} and the end of the uplink subframe UL SF1 for the target terminal 200 may correspond to the detection part during which the target terminal 200 receives the relay signal.

The second method is to receive a downlink MIMO signal only until its start time of the uplink subframe UL SF1 and receive a relay signal since its start time of the uplink subframe UL SF1. In this case, a rear portion of the downlink MIMO signal corresponding to TA_{MS} may not be received. That is, the duration of the uplink subframe UL SF1 may correspond to the detection part during which the target terminal 200 receives the relay signal.

If the target terminal 200 transmits an uplink signal transmission in an uplink subframe UL SF0 in front of the uplink subframe UL SF1, the target terminal 200 receives the relay signal after the elapse of a transmission/reception switching time T_{SW}. Accordingly, the detection part of the relay signal in the target terminal 200 is reduced to the period (T_{sf}−T_{SW}), rather than during the original duration T_{sf} of the uplink subframe UL SF1.

If there is an uplink signal transmission in an uplink subframe UL SF2 after the uplink subframe UL SF1, the target terminal 100 receives the relay signal until a time corresponding to before the transmission/reception switching time T_{SW} from its uplink reference timing. That is, the detection part of the relay signal in the target terminal 200 is reduced to the period (T_{sf}−T_{SW}).

As stated above, if there are uplink signal transmissions UL TX in both of the previous and next frames, the detection part of the relay signal in the target terminal 200 is reduced to the period (T_{sf}−2T_{SW}). If there is no uplink signal transmission in either the previous frame or the next frame, the target terminal 100 may receive the relay signal during the entire duration T_{sf} of the subframe.

In the above method for adjusting the transmission timing of the relay signal in the cooperating device 300, the cooperating device 300 may transmit the relay signal during the time left after subtracting a certain amount of time from the original duration of the subframe, and the target terminal 200 may receive the relay signal during the time left after subtracting a certain amount of time from the original duration of the subframe. Although relay signal transmission and reception during that subtracted amount of time results in losses of signal energy and data, these losses may be overcome by adjusting the coding rate and modulation scheme of cooperative MIMO signals to compensate for the losses.

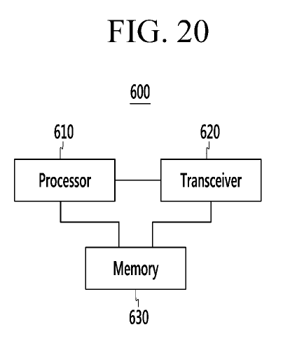

FIG. 20 is a view schematically showing a cooperative multi-antenna transmitting and receiving apparatus of a target terminal according to an exemplary embodiment of the present invention.

Referring to FIG. 20, a cooperative multi-antenna transmitting and receiving apparatus 600 of the target terminal 100 includes at least one processor 610, a transceiver 620, and a memory 630.

The at least one processor 610 performs the overall operation for the uplink cooperative MIMO signal transmission and reception, and the downlink cooperative MIMO signal transmission and reception, explained with reference to FIGS. 2 to 19. The uplink cooperative MIMO signal transmission and the downlink cooperative MIMO signal reception are performed independently by the at least one processor 610. The processor 610 may be implemented as a central processing unit (CPU), a chipset, a microprocessor, etc.

The transceiver 620 transmits and receives signals or messages for the uplink cooperative MIMO transmission and reception, and the downlink cooperative MIMO transmission and reception, to and from the base station 100 and the candidate cooperating devices (or cooperating devices) 300.

The memory 630 stores instructions to be executed by the processor 610 or loads instructions from storage (not shown) and temporarily stores them, and the processor 610 executes instructions stored in or loaded into the memory 630.

The processor 610 and the memory 630 are connected to each other via a bus (not shown), and an input/output interface (not shown) may be connected to the bus. In this case, the transceiver 620 is connected to the input/output interface, and peripherals such as an input device, a display, a speaker, and storage may be connected to the input/output interface.

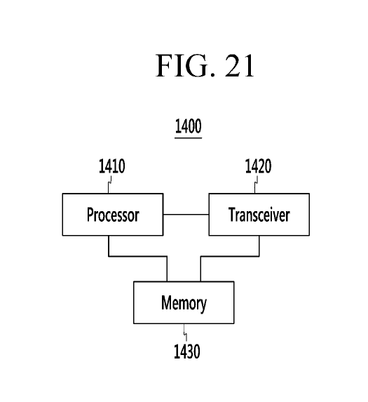

FIG. 21 is a view schematically showing a cooperative multi-antenna transmitting and receiving apparatus of a cooperating device according to an exemplary embodiment of the present invention.

Referring to FIG. 21, a cooperative multi-antenna transmitting and receiving apparatus 140 of the cooperating device 300 includes at least one processor 1410, a transceiver 1420, and a memory 1430.

The at least one processor 1410 performs the overall operation for relaying of uplink cooperative MIMO signal and the downlink cooperative MIMO signal, explained with reference to FIGS. 2 to 19. The relaying of the uplink cooperative MIMO signal transmission and the relaying of the downlink cooperative MIMO signal reception are performed independently by the at least one processor 1410. The processor 1410 may be implemented as a central processing unit (CPU), a chipset, a microprocessor, etc.

The transceiver 1420 transmits and receives uplink cooperative MIMO signal and the downlink cooperative MIMO signal between the base station 100 and the target terminal 200. Further, the transceiver 1420 transmits and receives signals or messages used for relaying of uplink cooperative MIMO signal and the downlink cooperative MIMO signal, to and from the base station 100 and the target terminal 200.

The memory 1430 stores instructions to be executed by the processor 1410 or loads instructions from storage (not shown) and temporarily stores them, and the processor 1410 executes instructions stored in or loaded into the memory 1430.

The processor 1410 and the memory 1430 are connected to each other via a bus (not shown), and an input/output interface (not shown) may be connected to the bus. In this case, the transceiver 1420 is connected to the input/output interface, and peripherals such as an input device, a display, a speaker, and storage may be connected to the input/output interface.

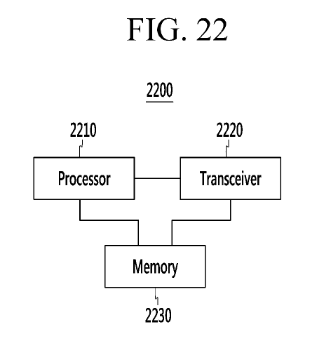

FIG. 22 is a view schematically showing a cooperative multi-antenna transmitting and receiving apparatus of a base station according to an exemplary embodiment of the present invention.

Referring to FIG. 22, a cooperative multi-antenna transmitting and receiving apparatus 2200 of the base station 100 includes at least one processor 2210, a transceiver 2220, and a memory 2230

The at least one processor 220 may perform a function corresponding to the cluster formation method explained in FIG. 2 or FIG. 3 to generate a cooperating cluster for a target terminal 200 for cooperative MIMO transmission and reception, and may periodically or non-periodically change or remove the cooperating cluster formed for the target terminal 200. The processor 2210 performs the overall operation for the uplink cooperative MIMO signal transmission and reception, and the downlink cooperative MIMO signal transmission and reception, explained with reference to FIGS. 2 to 19. The uplink cooperative MIMO signal reception and the downlink cooperative MIMO signal transmission are performed independently by the at least one processor 2210. The processor 2210 may be implemented as a central processing unit (CPU), a chipset, a microprocessor, etc.

The transceiver 2220 transmits and receives signals or messages for uplink cooperative MIMO transmission and reception and downlink cooperative MIMO transmission and reception, to and from the target terminal 200 and the candidate cooperating device (or cooperating devices) 300.

The memory 2230 stores instructions to be executed by the processor 2210 or loads instructions from storage (not shown) and temporarily stores them, and the processor 2210 executes instructions stored in or loaded into the memory 2230. The processor 2210 and the memory 2230 are connected to each other via a bus (not shown), and an input/output interface (not shown) may be connected to the bus. In this case, the transceiver 2220 is connected to the input/output interface, and peripherals such as an input device, a display, a speaker, and storage may be connected to the input/output interface.

According to an exemplary embodiment of the present invention, a target terminal is able to offer higher spatial multiplexing capability and greater spatial diversity than the number of terminal antennas allows, with the cooperation of cooperating terminals or cooperating repeaters.

Exemplary embodiments of the present invention are implemented not only through the apparatus and method, but may be implemented through a program that realizes functions corresponding to the configuration of the exemplary embodiments of the present invention or a recording medium in which the program is recorded. The invention can be easily implemented by those skilled in the art as described in the exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A cooperating cluster configuring method for a cooperative MIMO (Multiple-Input Multiple-Output) transmission and reception in a base station of a mobile communication system, the method comprising:
selecting a plurality of candidate cooperating devices to cooperate for the cooperative MIMO transmission and reception from among a plurality of repeaters for relaying signals and a plurality of terminals except a target terminal for cooperative MIMO transmission and reception;
selecting at least one cooperating device from among the plurality of candidate cooperating devices based on signal quality information measured between the plurality of candidate cooperating devices and the target terminal;
generating a cooperating cluster including the at least one cooperating device; and
transmitting configuration information of the cooperating cluster to the target terminal.

2. The method of claim 1, wherein the selecting at least one cooperating device comprises selecting a candidate cooperating device having a signal quality value higher than a threshold voltage as the cooperating device, based on a plurality of first signal quality values measured, by the target terminal, from discovery ranging signals sent from the plurality of candidate cooperating devices, respectively.

3. The method of claim 2, wherein the selecting at least one cooperating device further comprises:
calculating transmission timing offset values of the discovery ranging signals sent from the plurality of candidate cooperating devices, respectively; and
transmitting the transmission timing offset values to the plurality of candidate cooperating devices, respectively.

4. The method of claim 1, wherein the selecting at least one cooperating device comprises selecting a candidate cooperating device having a signal quality value higher than a threshold voltage as the cooperating device, based on a plurality of signal quality values measured, by the plurality of candidate cooperating devices, respectively, from a discovery ranging signal sent from the target terminal.

5. The method of claim 4, wherein the selecting at least one cooperating device further comprises:
calculating a transmission timing offset value of the discovery ranging signal sent from the target terminal; and
transmitting the transmission timing offset value to the target terminal.

6. A cooperative multi-antenna receiving method for a target terminal in a mobile communication system, the method comprising:
receiving a downlink cooperative MIMO signal directly through a downlink subframe from a base station;
receiving an amplified downlink cooperative MIMO signal transmitted through an uplink subframe, from a cooperating device selected from among a plurality of repeaters for relaying signals and a plurality of terminals except a target terminal for cooperative MIMO transmission and reception, wherein the downlink cooperative MIMO signal is received and amplified by the cooperating device; and
combining the downlink cooperative MIMO signal directly received from the base station and the amplified downlink cooperative MIMO signal received from the cooperating device and demodulating data.

7. The method of claim 6, wherein the receiving an amplified downlink cooperative MIMO signal transmitted through an uplink subframe comprises:
receiving a reception timing offset value calculated based on a propagation delay between the cooperating devices and the target terminal from the base station; and
receiving the amplified downlink cooperative MIMO signal at the reception timing adjusted by applying the reception timing offset value to the start time of the uplink subframe.

8. A cooperative multi-antenna transmitting method for a target terminal in a mobile communication system, the method comprising:
transmitting a first uplink cooperative MIMO signal in a first uplink subframe to a cooperating device selected from among a plurality of repeaters for relaying signals and a plurality of terminals except a target terminal for cooperative MIMO transmission and reception; and
transmitting a second uplink cooperative MIMO signal directly in a second uplink subframe to a base station,
wherein the first uplink cooperative MIMO signal is amplified by the cooperating device and an amplified first uplink cooperative MIMO signal is transmitted in the second uplink subframe, by the cooperating device, to the a base station.

9. The method of claim 8, wherein the transmitting a first uplink cooperative MIMO signal comprises:
receiving a transmission timing offset value calculated based on a propagation delay between the cooperating devices and the target terminal from the base station; and
transmitting the first uplink cooperative MIMO signal to the cooperating device at a transmission timing adjusted by applying the transmission timing offset value to the start time of the first uplink subframe.

10. The method of claim 8, wherein the first uplink cooperative MIMO signal is received at a reception timing adjusted by applying a reception timing offset value to the start time of a third uplink subframe by the cooperating device, and
the reception timing offset value is calculated based on a propagation delay between the cooperating devices and the target terminal by the base station.

11. A cooperative multi-antenna transmitting method for a cooperating device in a mobile communication system, the method comprising:
receiving a downlink cooperative MIMO signal in a downlink subframe from a base station;
amplifying the downlink cooperative MIMO signal; and
transmitting an amplified downlink cooperative MIMO signal in an uplink subframe to a target terminal.

12. The method of claim 11, wherein the transmitting the amplified downlink cooperative MIMO signal comprising:
receiving a transmission timing offset value calculated based on a propagation delay between the cooperating device and the target terminal from the base station; and
transmitting the amplified downlink cooperative MIMO signal to the target terminal at a transmission timing adjusted by applying the transmission timing offset value to the start time of the uplink subframe.

13. A cooperative multi-antenna transmitting method for a base station in a mobile communication system, the method comprising:
transmitting a downlink cooperative MIMO signal directly through a downlink subframe to a target terminal; and
transmitting the downlink cooperative MIMO signal in the downlink subframe, through a cooperating device selected from among a plurality of repeaters for relaying signals and a plurality of terminals except a target terminal for cooperative MIMO transmission and reception, to the target terminal,
wherein the downlink cooperative MIMO signal is transmitted in an uplink subframe, by the cooperating device, to the target terminal.

14. The method of claim 13, further comprising calculating a reception timing offset value of the target terminal and a transmission timing offset value of the cooperating device, based on a propagation delay between the cooperating device and the target terminal from the base station,
wherein a reception timing of the downlink cooperative MIMO signal by the target terminal using the reception timing offset value of the target terminal, or
a transmission timing of the downlink cooperative MIMO signal by the cooperating device using the transmission timing offset value of the cooperating device.

15. The method of claim 13, further comprising:
allocating the uplink subframe to the cooperating device;
measuring the received power of the downlink cooperative MIMO signal sent from the cooperating device to the target terminal; and
determining a reuse of the uplink subframe based on the received power.

16. The method of claim 13, further comprising:
allocating the uplink subframe to the cooperating device;
calculating the received interference power received by the target terminal from an uplink signal send from other user terminal; and
reusing the uplink subframe for the other user terminal based on the received interference power.

17. A cooperative multi-antenna receiving method for a base station in a mobile communication system, the method comprising:
receiving a first uplink cooperative MIMO signal in a first uplink subframe, through a cooperating device selected from among a plurality of repeaters for relaying signals and a plurality of terminals except a target terminal for cooperative MIMO transmission and reception, from a target terminal;
receiving a second uplink cooperative MIMO signal directly in a second uplink subframe from the target terminal; and
combining the first uplink cooperative MIMO signal and the second uplink cooperative MIMO signal and demodulating data.

18. The method of claim 17, further comprising calculating a transmission timing offset value of the target terminal and a reception timing offset value of the cooperating device, based on a propagation delay between the cooperating device and the target terminal from the base station,
wherein a transmission timing of the first uplink cooperative MIMO signal by the target terminal using the transmission timing offset value of the target terminal, or
a reception timing of the first uplink cooperative MIMO signal by the cooperating device using the reception timing offset value of the cooperating device.

19. The method of claim 17, further comprising:
allocating a third uplink subframe for transmitting of the first uplink cooperative MIMO signal to the target terminal cooperating device;
calculating the received power of the first uplink cooperative MIMO signal send from the target terminal to the cooperating device in the third uplink subframe; and
reusing the third uplink subframe for uplink transmission of other user terminal based on the received power.

20. The method of claim 17, further comprising:
allocating a third uplink subframe for transmitting of the first uplink cooperative MIMO signal to the target terminal cooperating device;
calculating the received power of the first uplink cooperative MIMO signal received by a cooperating device of other cooperating cluster, wherein the first uplink cooperative MIMO signal is transmitted in the third uplink subframe from the target terminal to the cooperating device; and
reusing the third uplink subframe for an uplink cooperative MIMO transmission of the other cooperating cluster based on the received power.
